(19) United States
(12) Patent Application Publication
(10) Pub. No.: US 2007/0296814 A1
(43) Pub. Date: Dec. 27, 2007

(54) SYSTEM AND PROCESS FOR CAPTURING, PROCESSING, COMPRESSING, AND DISPLAYING IMAGE INFORMATION

(76) Inventors: Benjamin J. Cooper, Bloomington, CA (US); Michael Ryan Baies, Flowey Branch, GA (US)

Correspondence Address: WILLIAM J. KOLEGRAFF, 3119 TURNBERRY WAY, JAMUL, CA, 91935, US

(21) Appl. No.: 11/674,059

(22) Filed: Feb. 12, 2007

Related U.S. Application Data
(63) Continuation-in-part of application No. PCT/US06/31509, filed on Aug. 11, 2006.
(60) Provisional application No. 60/707,996, filed on Aug. 12, 2005.

(51) Int. Cl. H04N 7/18; H04N 5/76

(52) U.S. Cl. 348/143; 348/231.99; 348/E07.085; 348/E05.024

(57) ABSTRACT

A process and camera system is provided for capturing and compressing video image information. The compressed data may be efficiently transmitted to another location, where cooperating decompression processes are used. The compression process first captures a background image, and transmits the background image to a receiver. For each subsequent image, the image is compared at the camera to the background image, and a change file is generated. The change file is then transmitted to the receiver, which uses the background image and the change file to decompress the image. These changes may be aggregated by both the camera and the receiver for even better compression. In some cases, the background may be removed from the displayed image at the receiver, thereby displaying only changing image information. In this way, a display is less cluttered, enabling more effective human or automated monitoring and assessment of the changing video information.

This application is a continuation-in-part to International application PCT/US2006/031509, filed Aug. 11, 2006, and entitled “System and Process for Capturing, Processing, Compressing, and Displaying Image Information”, which claims priority to U.S. patent application 60/707,996, filed Aug. 12, 2005, and entitled “System and Process for Capturing, Processing, Compressing, and Displaying Image Information”:, both of which are incorporated herein by reference.

### BACKGROUND

Many systems today provide for the capturing, transmission, and displaying of video information. Video information typically comprises a large amount of data, so may be compressed prior to transmission. To accomplish this compression, many proprietary or standard compression process have been developed and deployed. For example, MPEG-4 is a popular standard compression system for reducing the amount of data transferred in a video transmission, and to reduce video file sizes. However, even video files compressed with current compression techniques can be quite large, and can in order to efficiently transfer video, the vide data may be compressed to the point where video quality is lost.

In one example of remote video usage, one or more video cameras may be arranged to monitor an area for security purposes. These cameras continuously record video data, typically compress that data, and transmit the compressed video data to a central location. At the central location, the data is decompressed and monitored, often by a security guard. In this way, the security guard monitors one or more displays for unexpected movements or the presence of unexpected objects or people. Such manual monitoring may be quite tedious, and some security breaches may be missed due to lack of attention, mis-directed focus, or fatigue. Although some automated monitoring and analysis may be used to assist the security guard, security decisions are still primarily made by a human.

Complicating matters, the transmission link from a security camera to the central location may be a relatively low bandwidth path. In this way, the security video information must be reduced to accommodate the limited transmission path, so the frame rate is typically reduced, or the data is compressed to the point where resolution and detail is compromised. Either way, the security guard would be presented with lower quality video data, which makes monitoring more difficulty.

### SUMMARY

Briefly, the present invention provides a process and camera system for capturing and compressing video image information. The compressed data may be efficiently transmitted to another location, where cooperating decompression processes are used. The compression process first captures a background image, and transmits the background image to a receiver. For each subsequent image, the image is compared at the camera to the background image, and a change file is generated. The change file is then transmitted to the receiver, which uses the background image and the change file to decompress the image. These changes may be aggregated by both the camera and the receiver for even better compression. In some cases, the background may be removed from the displayed image at the receiver, thereby displaying only changing image information. In this way, a display is less cluttered, enabling more effective human or automated monitoring and assessment of the changing video information.

### BRIEF DESCRIPTION OF THE DRAWINGS

Figure A shows a security system in accordance with the present invention.

Figure B shows a process for compressing, transmitting, and displaying security information in accordance with the present invention.

Figure C shows a process for compressing, transmitting, and displaying security information in accordance with the present invention.

FIG. 00 shows a control and data flow diagram for a security image process operating on a camera in accordance with the present invention.

FIGS. 01 to 35 show a sequence of process steps for implementing a security image process in accordance with the present invention.

### DESCRIPTION

Referring now to Figure A, security system 1 is illustrated. Security system 1 has first camera 2 directed toward a security target. For example, the security target may be a street, a train station, an airport corridor, a building interior, or another area where security image monitoring is desired. Camera 2 is constructed to have one or more fixed relationships with the security target. In this way, camera 2 may have a first fixed relationship with the security target as shown in Figure A. Then, camera 2 may rotate to a second fixed position as shown by reference character 2a. In this way, camera 2 may monitor a larger security area while still enabling fixed camera positions. Camera 2 is constructed with a camera or image sensor for detecting background and transition elements in the security target. The sensor may be, for example, a CCD image sensor, a motion video camera, an infrared sensor, or another type of electromagnetic sensor. Camera 2 captures a series of images, and applies compression and security processes to the image data for transmission through a communication link 4. The particular compression and security processes will be discussed in more detail below.

Communication link 4 may be, for example, an Internet connection, a wireless local network connection, or a radio transmission connection. It will be appreciated that communication linked 4 may take many alternative forms. The communication link 4 also connects to the receiver 5. Receiver 5 is constructed to receive the background and compressed information from the cameras, and present security information in the form desirable for security monitoring. In one example, the target image is displayed with near real-time display of transitional or moving objects. In this way, the display shows a substantially accurate and current view of the entire target as captured by the camera. In another example, the display is used to present only transitional or moving elements. In this example, the static background is removed from the display, so only new or moving objects are shown. In another example, the new and moving objects may be presented on a deemphasized or dimmed background. In this way, the new and changing information is highlighted, but the background is still somewhat visible for reference purposes.

Receiver 5 may also connect to a computer system for further processing of the security information. For example, the computer may be programmed to search for and identify certain predefined objects. In one particular example, the computer may be predefined to search for and identify a backpack left in the security target area for more than one minute. Upon the computer finding a backpack unmoved for more than one minute, the computer may generate an automatic alert. In a more basic example, the computer may analyze a moving object to determine if it is likely a human or a small pet. If a human is detected, and no human is supposed to be at the target area, then an alert may be automatically generated.

Security system 1 may also operate with multiple cameras, such as camera 3. When operating with multiple cameras, a single security target area may be watched from multiple angles, or multiple security target areas may be monitored. It will also be appreciated that multiple receivers may be used, and that different cameras may use different communication links.

Advantageously, security system 1 enables a highly efficient transfer of image data from one or more cameras to the associated receiver system. Since the data transmissions are so efficient, near real-time representation of moving and changing objects may be displayed using a relatively low-speed communication link. Further, a communication link may support more cameras then in known systems, and may still provide acceptable image quality, resolution, and motion.

As previously described, the communication link 4 provides for communication between the receiver 5, the computer, and the cameras 1 and 2. Typically, the communication link 4 will be implemented as a radio link, network data link, or an Internet link. When initially operated, the cameras and receiver may operate according to default image capture and transfer settings. For example, the cameras may be set to monitor the largest possible viewing area, and may be set to the highest level of data compression. In this way, the display is initially able to show the entire monitored area with a relatively small data transfer.

However, it may be desirable to allow the receiver 5 to automatically adapt camera settings according to the received image. For example, the receiver 5 may determine that image quality or detail is insufficient, and sends image quality information through the communication link 4 to one or more cameras. The image quality information could hold instructions to increase resolution in some areas, decrease resolution in some areas, adjust window size, change aperture or iris settings, adjust frame rate, or adjust algorithmic factors operating on the camera. In another example, the receiver may notify all cameras to adjust resolution, compression, or frame rate responsive to the aggregate number of cameras operating or image information being received. It will be appreciated that the information feedback from the receiver 5 to the camera or cameras may take may forms. By providing for receiver feedback, the security system 1 allows the automated and near real-time adaptation of changing security environment.

In other feedback example, the computer, either though the receiver connection or a separate connection, sets or adjusts one or more security cameras 1 and 2. Since the computer is likely to have additional processing power, the computer may be able to make additional image determinations, and set camera settings accordingly. Further, the computer, either automatically or using operator input, may identify targets of interest, and make adjustments intended to provide additional detail regarding the target. For example, the computer may determine that an unexpected object has been stationary in a hallway, and that the unexpected object has the general characteristics of a backpack. The computer system may set a local alert to notify a security guard, and also send commands to the camera to increase resolution in the window where the backpack is found. The computer may also increase frame rate, increase color depth, or adjust other camera settings or algorithmic factors to increase the identifiablity of the backpack.

Referring now to Figure B, a general security image process 10 is illustrated. Security image process 10 may operate on, for example, a security system as illustrated with reference to figure A. It will be appreciated process 10 may also apply to other camera and receiver arrangements. Security image process 10 has steps performed on the camera side 16 as well as a steps performed on the receiver side 18. Further, some of the steps may be defined as setup steps 12, while other steps may be classified as real-time operational steps 14.

Image process 10 has an image sensor having a fixed position relationship with an image target, as shown in block 21. The image sensor is used to capture a first setup image as shown in block 23. The setup image may be taken, for example, at a time when only background information is available in the image target. In a more specific example, the setup image may be taken when a corridor or hallway is empty, so that the entire background image may be captured at once. In an example where the camera may rotate to more than one fixed positions, a setup image may be captured for each fixed position. Also, it will be understood that the setup image may be updated from time to time during operation. For example, the setup image will may change or according to the time of day, or according to the actual activity at the image target.

Once the setup image has been captured, the setup image is defined as the background frame as shown in block 25. The background frame is communicated to the receiver, where the background frame is stored as shown in block 27. Since the transmission of the background frame is part of the setup process 12, the background frame may be transmitted at selected times when the communication link may be used without impacting near real-time transmissions. At the completion of the setup processes 12, both the sensor side 16 and the receiver side 18 have a common stored background frame reference.

During near real-time operations 14, the camera captures a sequence of images, performs compression processes, and communicates the compressed information to the receiver. In particular, the sensor captures a next image as shown in block 30. For each image, the background is subtracted from the captured image to reveal those pixels or blocks of pixels that have changed from the background, as shown in block 32. Depending on the resolution required, and the particular application, this compression process may operate on individual pixels, or on blocks of pixels, for example a 4×4 or 8×8 block. The changed pixels or blocks are organized into a change file as illustrated in block 34. This change information is then communicated to the receiver. Since during near real-time operation only change information is being transmitted, a highly efficient near real-time image transfer is enabled.

System 10 is particularly efficient when the security area has a large static background with minimal temporal change. For example, security system 10 would be highly efficient in monitoring a hallway in a building after work hours. In this example, there may be no activity in the hallway for extended periods of time. Only when the image changes, for example when a guard walks down the hallway, will any change occur. Continuing this example, the only information transmitted from the camera to the receiver would be the changed pixels or blocks relating to the image of the guard. Once the guard has left the hallway, no further change transmissions would be needed.

During the near real-time process 14 on the receiver side 18, the receiver recalls the stored background as shown in block 36. The image may then be displayed as shown in block 38. To assist in emphasizing any changes to the background, the background image may be displayed in a deemphasized or dimmed manner. For example, the background may be displayed using shades of gray, while changes are displayed in full color. In another example, the background may be displayed in a somewhat transparent mode while change images are fully solid. It will be appreciated that the background may also be toggled on and off by an operator or under receiver control. In this way, an operator may choose to remove the static background to assist in uncluttering the display and allowing additional attention to be focused on only changed items. In another example, the receiver or an associated computer may turn off the displaying to draw additional attention to particular change items.

Since the receiver has a stored background for the security target, it receives only change information from the sensor. The received change information may then be displayed as an overlay to the background as shown in block 40. In one refinement, a sensitivity may be specified to the level of change. In this way, minute or insignificant changes may be blocked from the display, thereby focusing operator attention on more important changes. These unimportant changes, may be, for example, caused from environmental conditions such as wind, very small items such as leaves blowing through the target image, or other minor or insignificant changes. It will be appreciated that this sensitivity may be set at the camera side, at the receiver side, or on both sides.

Security process 10 may also allow an operator to update the stored static background without having to capture a complete new background image. For example, if a chair is moved into the background, the chair would show as new or changed blocks in the change file. If an operator determines that the chair is not of security interest, the operator may select that the chair be added to the background. In this way, the chair would not be displayed as new or changed pixels in following displays. In an extension to this example, the receiver may communicate back to the camera that the chair has been added to the background, and then the camera may stop sending chair pixels as part of the change file. Alternatively, the camera may retake its background frame, and the chair will be added to the new background.

Referring now to figure C, another image security process 50 is illustrated. Security process 50 has a camera process 56 operating, as well as a receiver process 58. Both the camera and the receiver have setup processes 52, as well as processes 54 operating during near real-time operation. During setup, the camera has a sensor which is arranged to have a fixed position with an image target. It will be understood that more than one fixed position may be available, and that a different setup image may be taken for each fixed position. For each fixed position, the sensor captures an image of the target area as shown in block 63. The image of the target area is then stored as a background frame as shown in block 65. This background frame is also transmitted to the receiver where it is stored as the background frame as shown in block 67.

At the camera, the background frame has been stored in background file 79. Then, the camera captures a sequence of images as shown in block 69. Each captured image is then compared with background 79 to expose changed blocks or pixels as shown in block 71. The new or changed blocks are then added to a transient file 81 as shown in block 73. The transient file 81 is used to aggregate and collect changes as compared to the primary background 79. In particular, transient file 81 may be used to further compress image information and reduce the amount of data transferred from the camera to the receiver. For example, transient file 81 identifies new blocks as they appear in the background. If these blocks move in successive frames, then rather than sending the new blocks again, a much smaller offset value may be transmitted. Take for example a ball rolling across a background. The first time the ball appears in an image, the transient file will have the new ball images added. In the next frame, the ball may still be present, though offset by a particular distance. Rather than resending all the pixels or blocks representing the ball, offset values may be more efficiently transmitted as part of the change file. Accordingly, the camera generates a change file that identifies new blocks and offsets for blocks that have been previously transmitted as shown in block 77. It will also be appreciated that some items in the transient file 81 may be added to the background file 79. For example, if the setup image was taken while a ball was rolling across the background, the background area behind the ball would not originally appeared in background file 79. However, over time, it may become apparent that that area may be appropriately and safely added to the background 79. Although process 50 is illustrated with a background and a transient file, it will be appreciated that additional files may be used to store different levels and types of changes.

At the receiver side 58, a copy of the background 84 is also stored. As described with reference to figure B, the background may be recalled as shown in block 88 and displayed as shown in block 90. The receiver also receives the change file generated by the camera. The received change file is then used to update the receiver transient file 86, and to generate the blocks or pixels to be displayed as an overlay to the static background as shown in block 92. The transient file 86 is updated according to the received change file so that transient file 86 is the same as transient file 81. Since both the receiver and the camera have the same background and transient files, change information may be very efficiently communicated. Once the receiver has generated the proper overlay blocks or pixels, the blocks or pixels are displayed on the display as shown in block 94.

Although Figures A to C have been described with reference to a video security system, it will be appreciated that the process described herein has other uses. For example, the described image process may be advantageously used to monitor chemical, manufacturing, or other industrial processes. In a particular example, a fixed camera is pointed to a set of exhaust pipes for a manufacturing facility. A primary background image is taken when the exhaust pipes are emitting an expected mixture of exhaust. The defined image process may then monitor for a new or unexpected exhaust pattern. As an industrial monitoring system, the defined process may be used to monitor fluid flows, processing lines, transportation facilities, and operating equipment. It will also be appreciated that image areas may be defined where no activity is to be reported. For example, a transportation yard may have expected and heavy traffic in defined traffic lanes. These traffic lanes may be predefined so that any movement in an expected area will not be transmitted. However, if a vehicle or other object is found moving outside the expected traffic lanes, the movement information is efficiently transmitted to a central location. This acts to effectively filter and preprocess graphical information for more effective and efficient communication and post processing.

More generally, the image processing system described herein acts as a powerful preprocessor for image processing. For example, certain types of graphical data may be advantageously filtered, emphasized, or ignored, thereby increasing communication efficiency and highlighting useful or critical information. For example, the image processing system may effectively eliminate background or other noncritical graphical data from communication processes, security displays, or intelligent identification processes. As a further enhancement, the image processing system may have sets of files, with each file holding a particular type of graphical information. For example, graphical files may be created for slow moving objects, fast-moving objects, and for non-moving new objects. Since the image processor has automatically generated these files, particular analytical processes may be performed according to the type of data expected in each file.

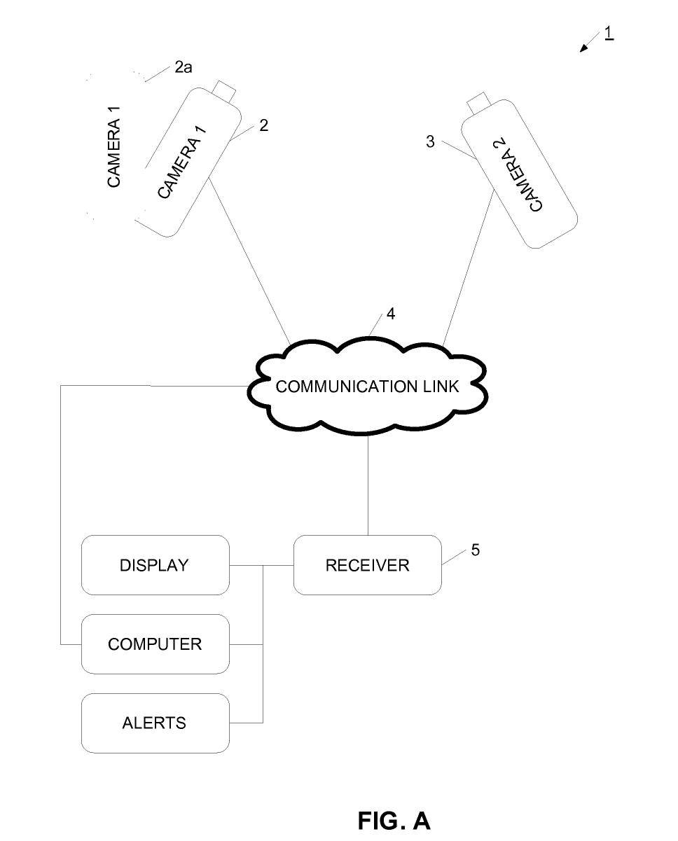

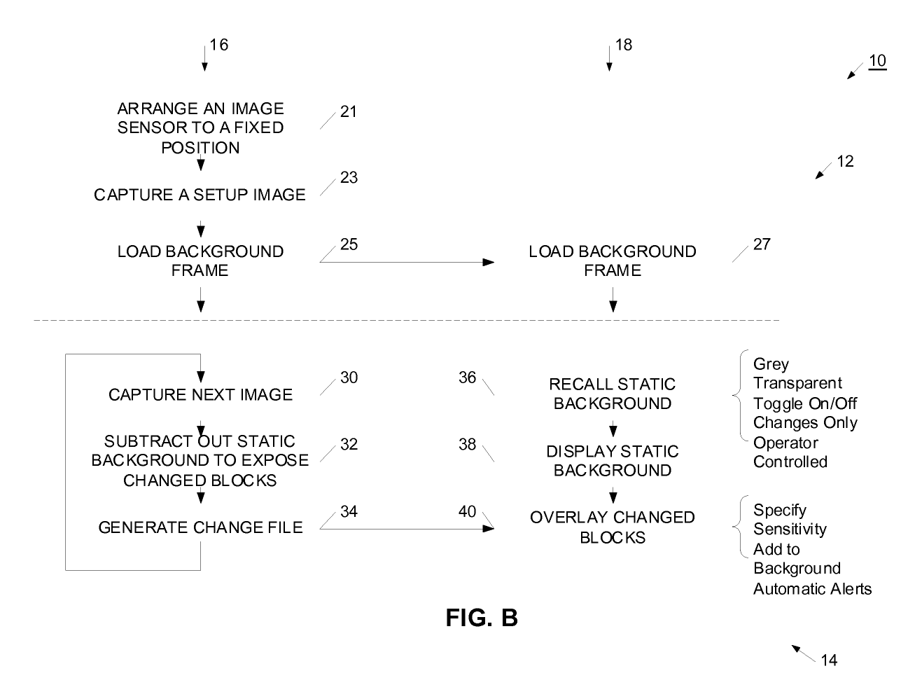

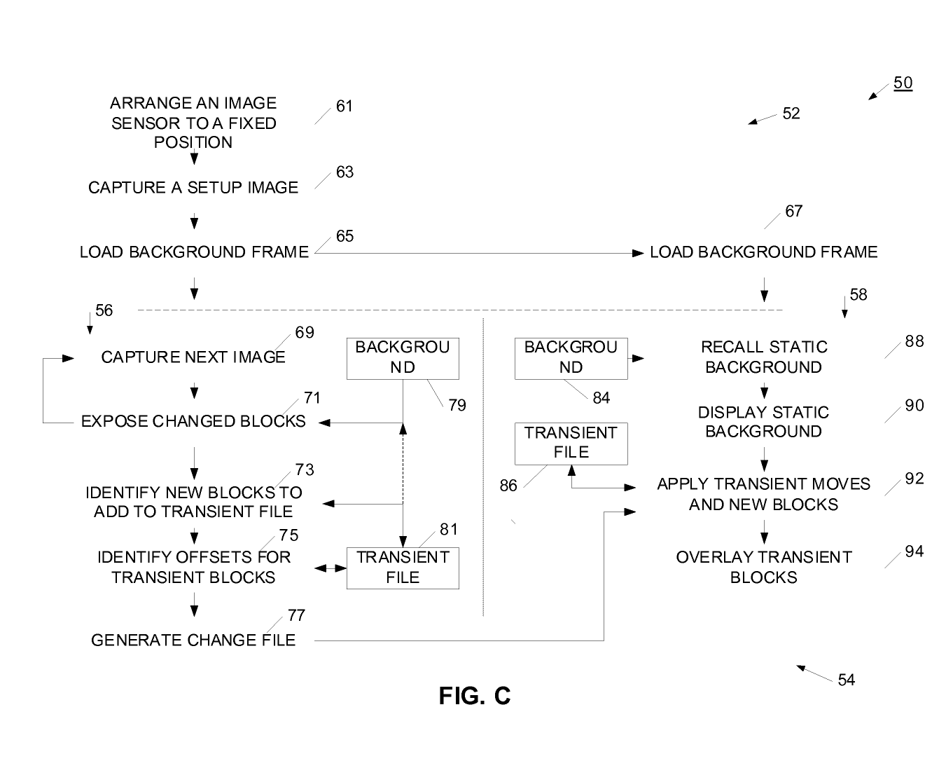

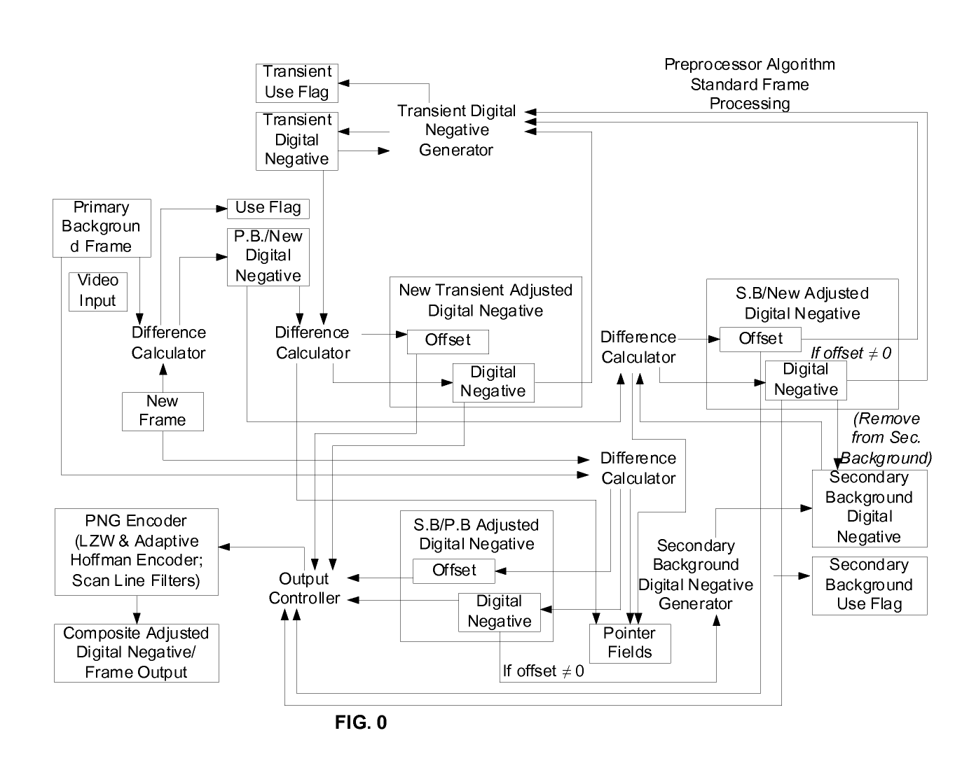

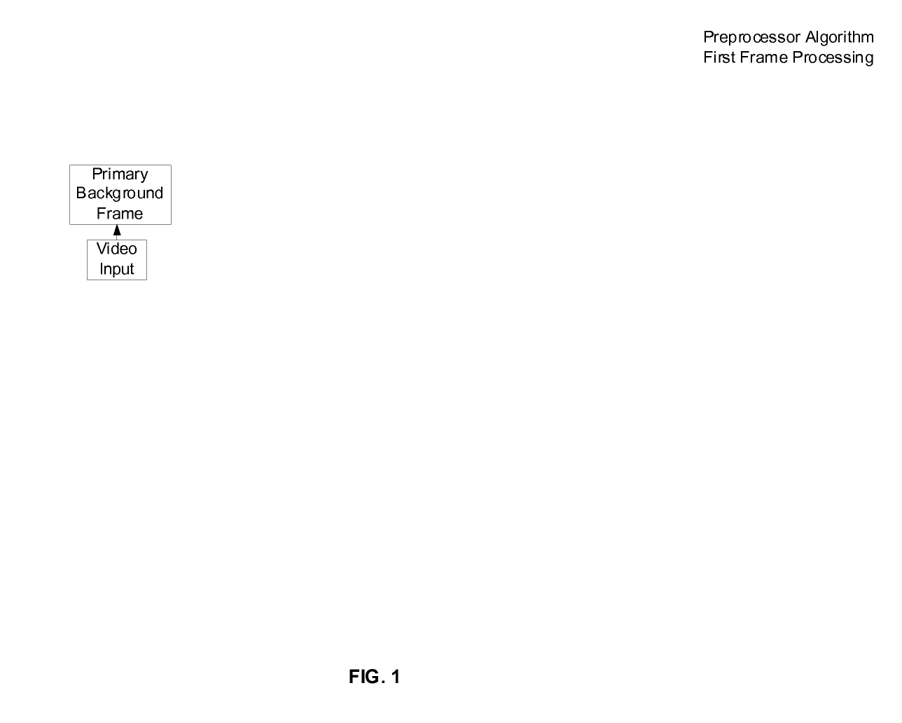

With the image security process generally described, a more specific implementation will now be described. FIG. 00 to FIG. 35 described a series of detailed process steps for implementing any particularly efficient security process on a camera sensor. More particularly, FIG. 00 illustrates the overall command and data flow for the camera security process, while FIGS. 01 to 35 illustrate sequential process steps. Each of the FIGS. 00 to 35 will be described below.

FIG. 00.

FIG. 00 shows a process for preprocessing frames of video data. This process is intended to process video input from a video camera, and output compressed and filtered image data to a remote receiver.

It will be understood by one skilled in the programming arts that many of the modules and methods described in the process for preprocessing operate according to factors that may be static, automatically adapted, or manually adapted. These factors may include, for example, block size, motion estimation thresholds, window size, search area, difference thresholds, quality factors, and target compression ratios. It will be understood that many other or alternative factors may be used. In operation, these factors are likely to have an initial default value, and then may be adapted according to system operation. For example, a factor may be adapted responsive to 1) a camera condition; 2) another algorithm factor; 3) instruction received from the receiver, 4) a command received automatically from the computer; or 5) a command received according to an operator request.

FIG. 01.

FIG. 01 shows the video camera providing one frame of video input. The frame of video input is loaded as the primary background frame in the camera. It will be appreciated that the primary background may be collected once at startup, updated periodically, or updated according to algorithmic processes. In one example, the video camera is a fixed position camera having a static relationship with the background. In another example, the camera rotates or moves to multiple fixed positions. In this case, each of the fixed positions may have its own primary background frame. For ease of explanation, a single fixed point video camera is assumed for the explanation.

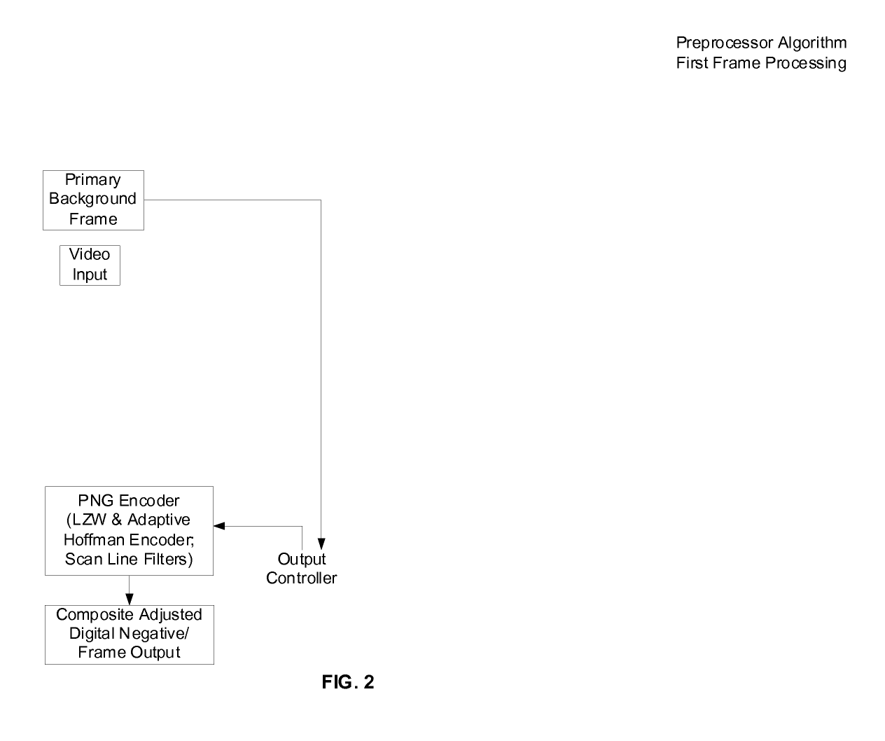

FIG. 02.

FIG. 02 shows that the primary background frame is communicated to the receiver. More particularly, the primary background frame is compressed according to known compression algorithms and transmitted via standard wired or wireless technologies. In this way, the receiver and the camera each have the same primary background frame available for use.

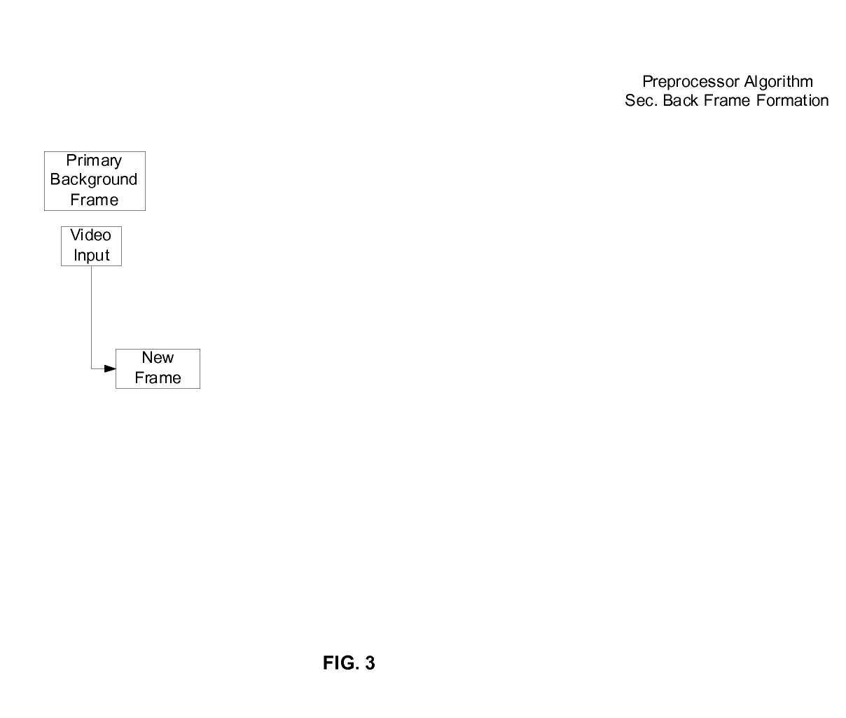

FIG. 03.

In some cases, the primary background frame may fully and completely set out the static background. However, in most practical cases, the initial primary background frame may be incomplete or subject to change over time. To facilitate updating and completing the background, the video preprocessor allows for the formation of a secondary background frame. Generally, the secondary background frame stores information that the preprocessor algorithm finds to be more easily handled as a background information. The secondary background formation begins with a new frame being collected by the camera as shown in FIG. 03. Although FIG. 3 shows the process operating on the second frame, it will be appreciated that the secondary background formation process may be operated on other frames, as well as even on all the frames. In another example, the background frame formation process maybe operated periodically, or responsive to another algorithmic process. However for purposes of explanation, it will be assumed that the background frame formation is operated on all frames subsequent to capturing the primary background frame.

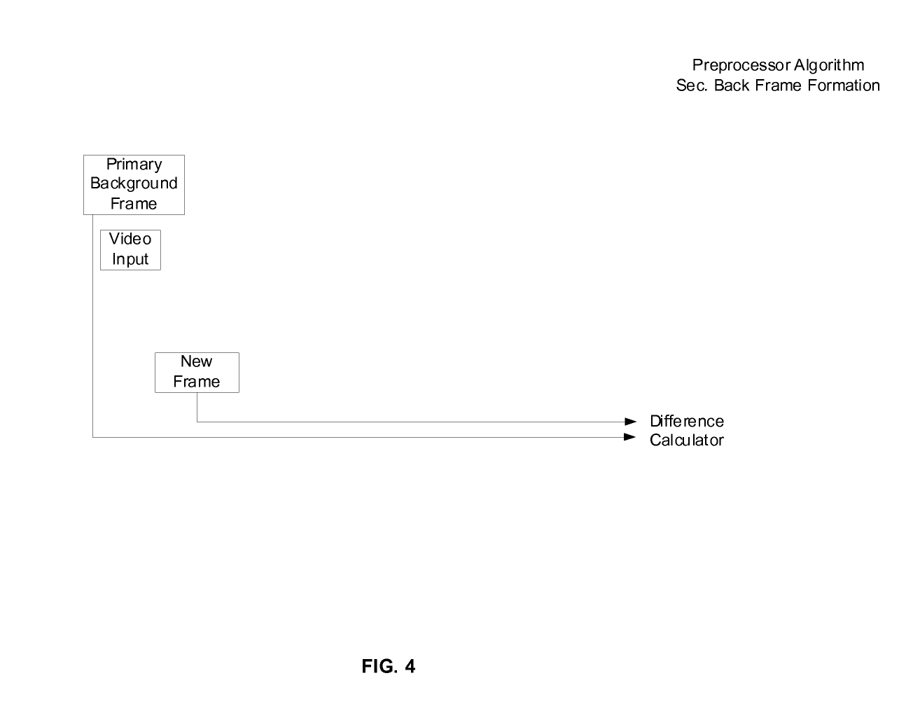

FIG. 04.

FIG. 04 continues the secondary background frame formation. The primary background is compared to the new frame using a difference calculator. The difference calculator is used to numerically compare the background to the new frame. For pixels or blocks that did not change, the difference will be “0”. The difference calculator is used to identify changes from one frame to another frame. A change can either be a change to a pixel or block, for example, when an item first enters the new frame, or the change can be a pixel or block that has moved. For a moved pixel or block, the difference calculator can calculate a set of offset values. For those pixels or blocks that have moved, an offset value is generated. It will be appreciated that image processing may be done on a pixel by pixel basis, of on a larger block of pixels. For more efficient processing and communication, operation on 4×4 or 8×8 pixel blocks has proven effective.

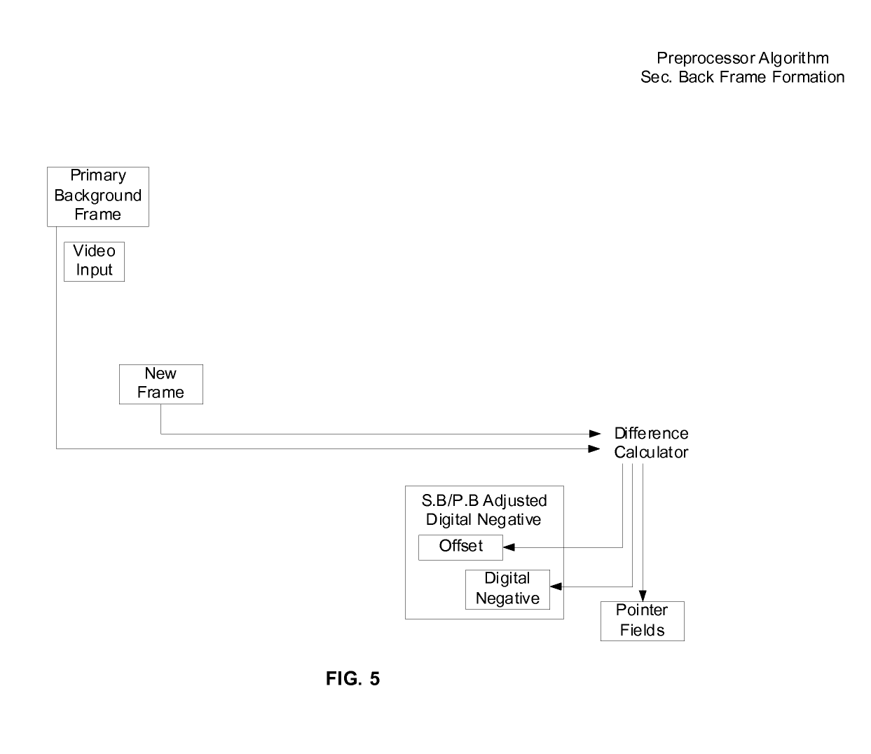

FIG. 05.

FIG. 05 shows that the secondary background has been compared to the primary background, and a set of offset values and a digital negative has been generated. As described with reference to FIG. 04, the difference calculator identifies pixels or blocks that have changed, and for pixels or blocks that have move, generates offset values. In the present implementation, the new or different pixels/blocks are stored as a digital negative, and the offset values are stored in an offset file. Together, the digital negative and the offset values is referred to as an adjusted digital negative. For purpose of clarity, it is to be understood that the adjusted digital negative may be processed with the appropriate reference background to create an original frame.

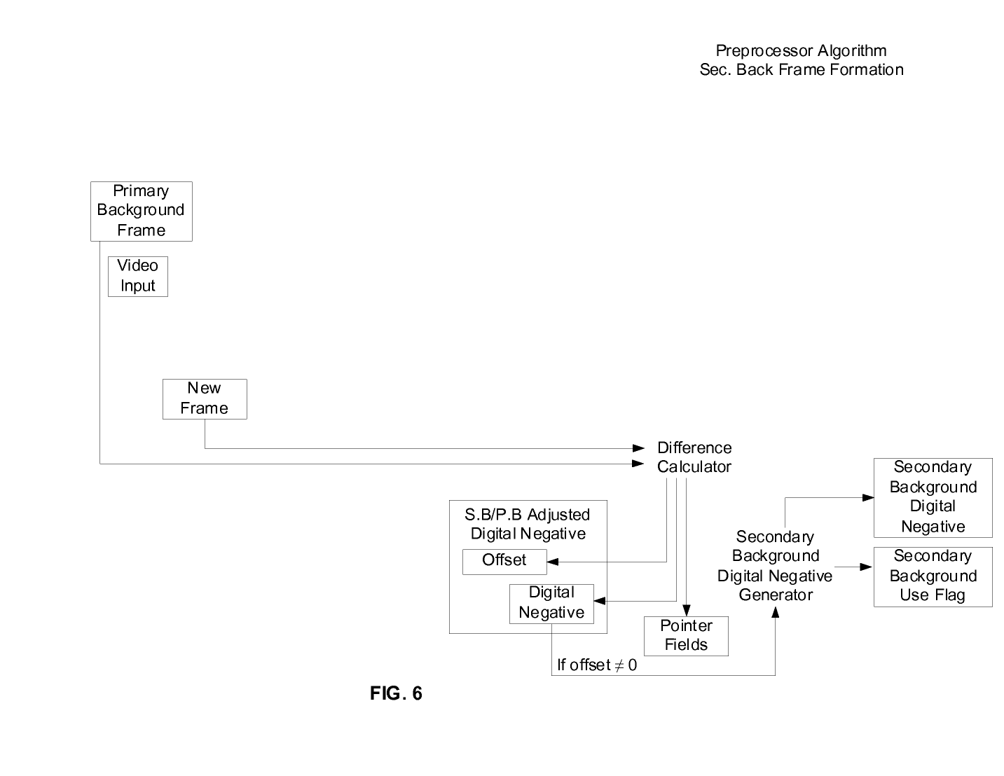

FIG. 06.

As shown in FIG. 06, if a pixel block is found in the digital negative that has an offset value of “0,0”, this means that the “0,0” block is appearing for the first time. If the block has any other offset value, that means the pixel block has moved from a location in a previous frame. Since this new pixel block may be part of the background, that pixel block is added to the secondary background. Also, a secondary background use a flag is set for indicating that the secondary background has been updated responsive to this video frame.

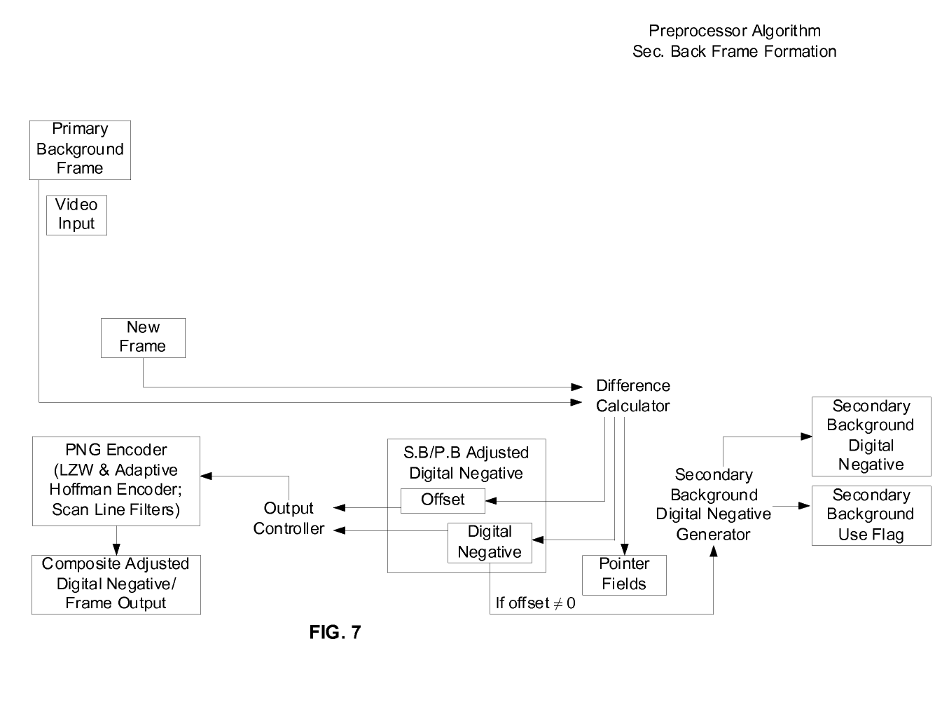

FIG. 07.

FIG. 07 shows that the offset and digital negative values are compressed and communicated to the receiver. In this way, the receiver maintains a secondary background file and use flag like the files maintained by the camera. The receiver may then process the received offset and digital negative with its stored primary background to create a duplicate of the “new frame”. Using this “summing” process, the receiver uses adjusted digital negatives and saved reference frames to efficiently create and display images like the images capture at the camera.

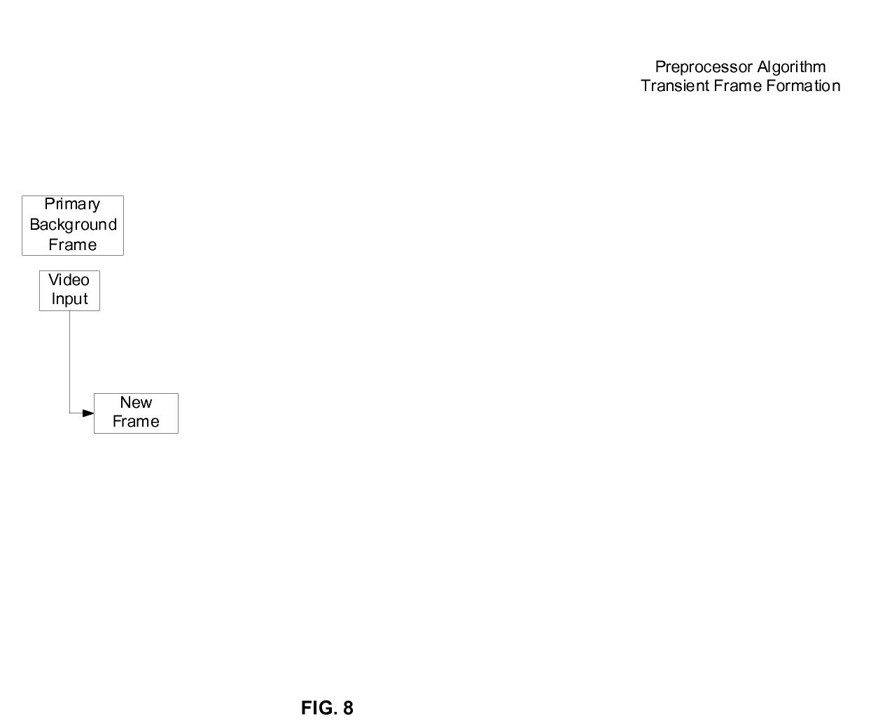

FIG. 08.

When a set of pixels or pixel block first up here is in a frame, it is not known when if the new pixels are part of the secondary background or are objects moving through the target area. Accordingly, the preprocessor algorithm assumes that new pixels are part of the background, and therefore initially added into the secondary background frame. Another process is used to identify transient objects moving to the target area. Once an object is being treated as a transient, it is removed from the secondary background. The transient frame formation process is described in FIG. 08 to FIG. 18. Referring now to FIG. 8, another video frame is captured. Although FIG. 08 shows that a third frame has been captured, it will be appreciated that the transient frame formation maybe operated on other frames. For ease of explanation, the newly captured frame will be referred to as the third frame.

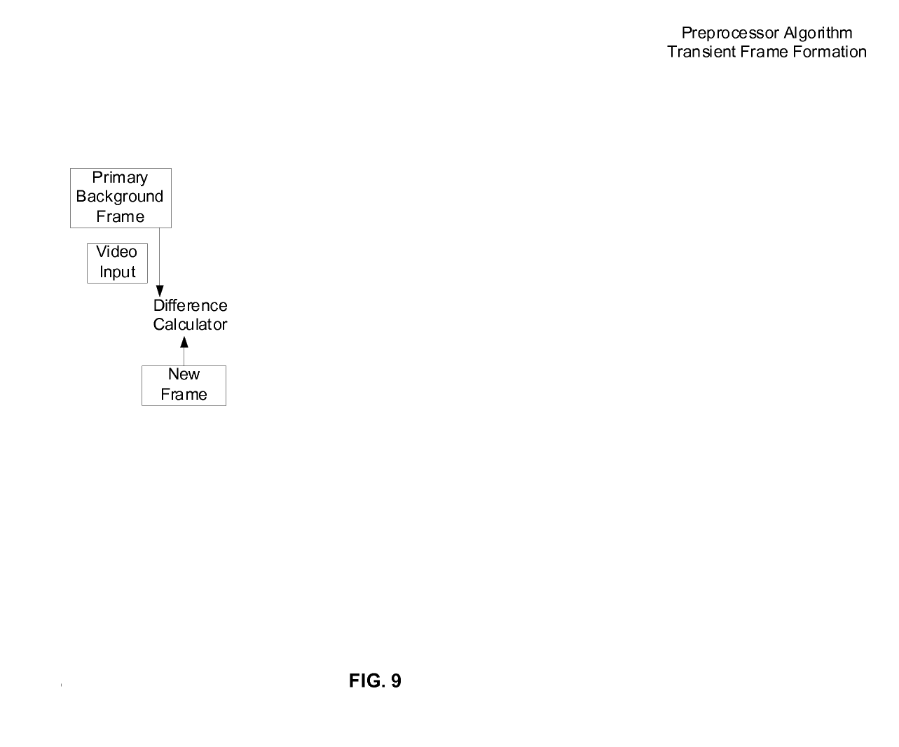

FIG. 09.

FIG. 09 shows that the third frame is being compared to the primary background frame using a difference calculator.

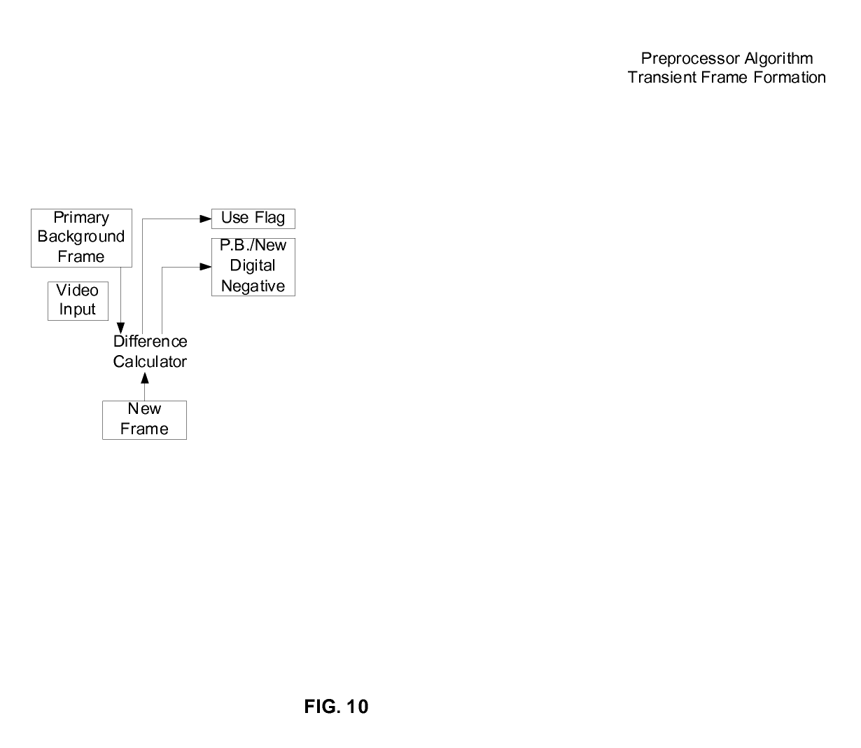

FIG. 10.

FIG. 10 shows that the comparison of the primary background frame to the third frame generates a difference file in the form of a digital negative and a use flag.

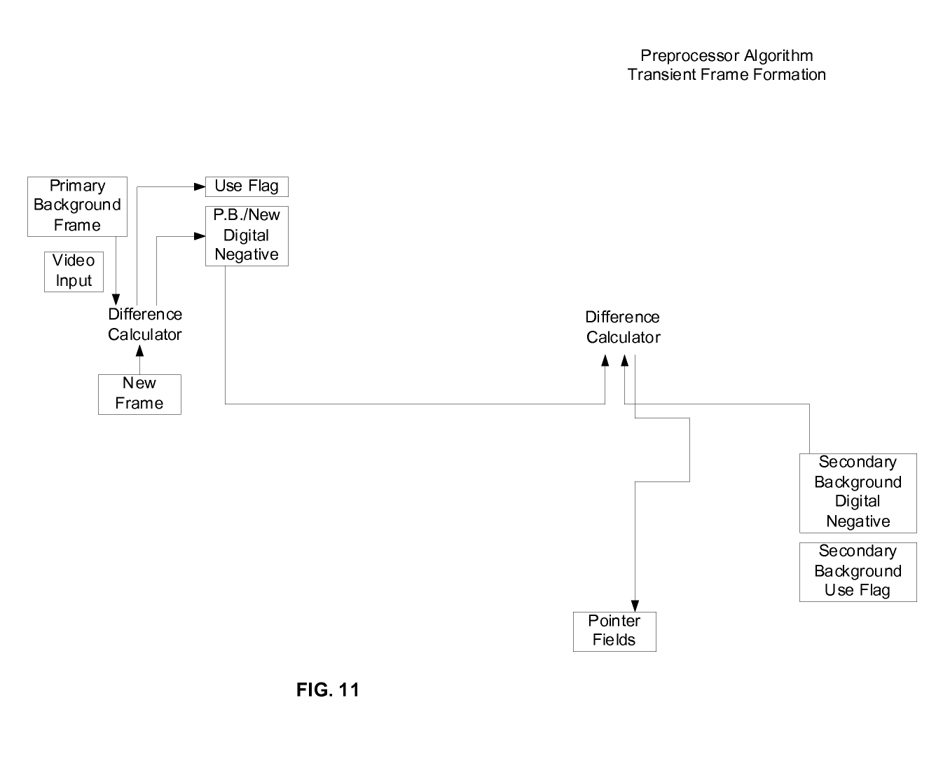

FIG. 11.

FIG. 11 shows that the differences between the third frame and the primary background frame are compared to the secondary background file. Generally, this comparison determines if an object, which is not in the primary background frame, has been previously added to the secondary background.

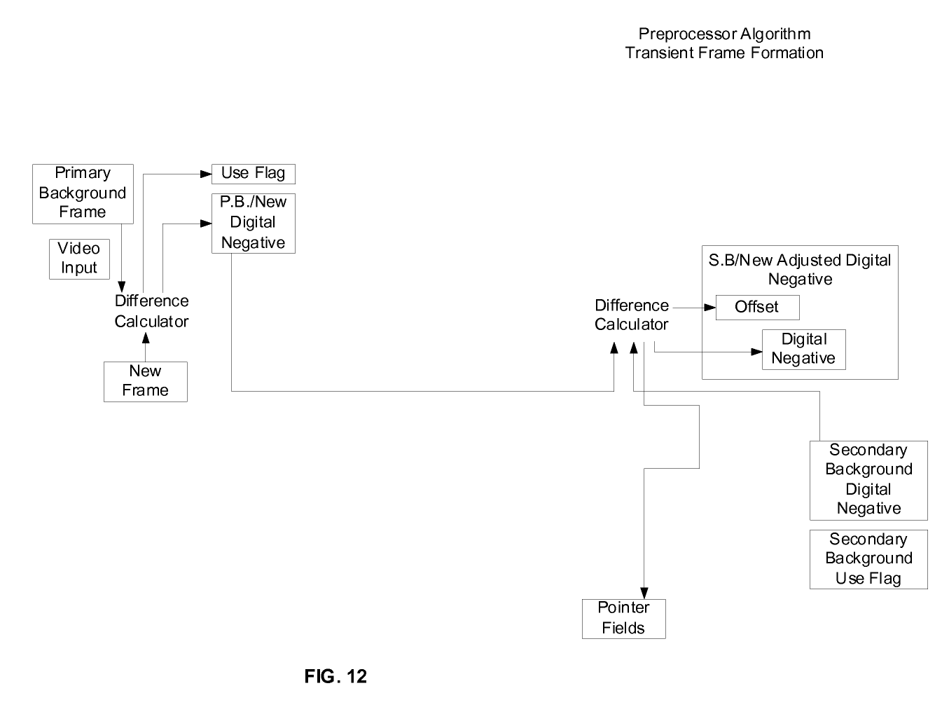

FIG. 12.

More particularly, the comparison discussed in FIG. 11 generates a digital negative and offset value comparing the secondary background to the third (new) frame. If the digital negative has objects with an offset of “0,0”, this is indication that this object is not moving, and therefore may stay in the secondary background file. However, if an object is offset from its position in the secondary background, that object may then be identified as a transient moving in the target area.

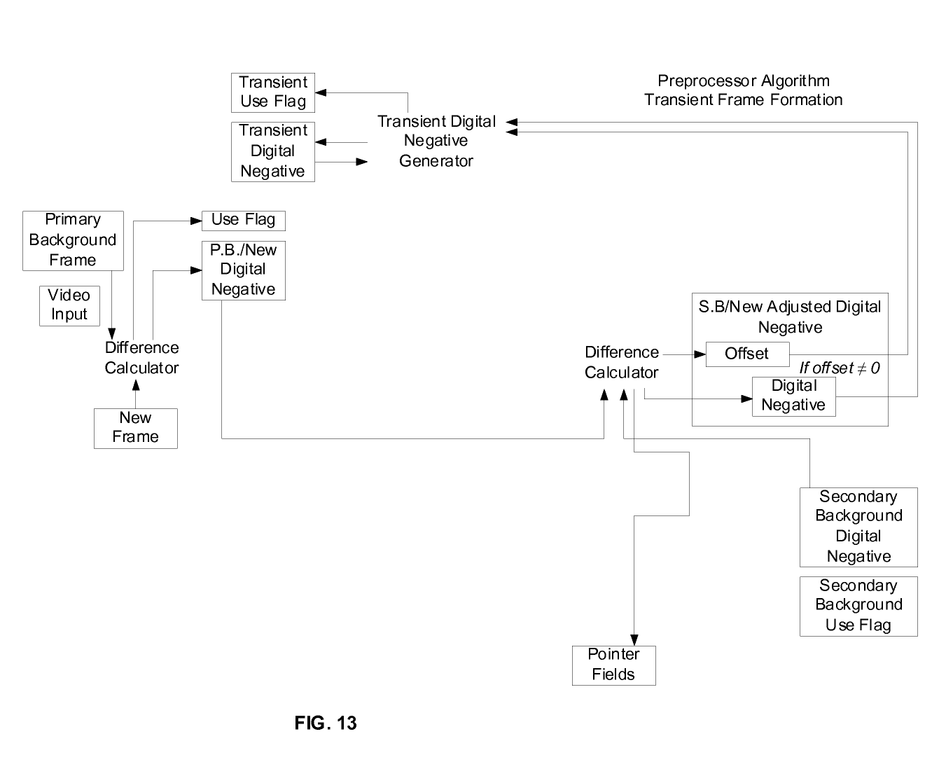

FIG. 13.

Continuing the description from FIG. 12, for those objects, pixel blocks, or pixels that are offset from their position in the secondary background, those moving objects are placed into a transient file in the form of a transient digital negative and a transient use flag. It will be understood that the word “object” is used broadly while describing the preprocessor algorithm. For example, the object may be a few pixels, a set of blocks, or an intelligently defined and identified item. In this regard, another process and set of files may be used to track and maintain information for certain predefined objects. In a particular example, the preprocessor algorithm may have processes to identify a particular item, such as a backpack. Once a backpack has been identified, it may be tracked and monitored using a separate file and processing system.

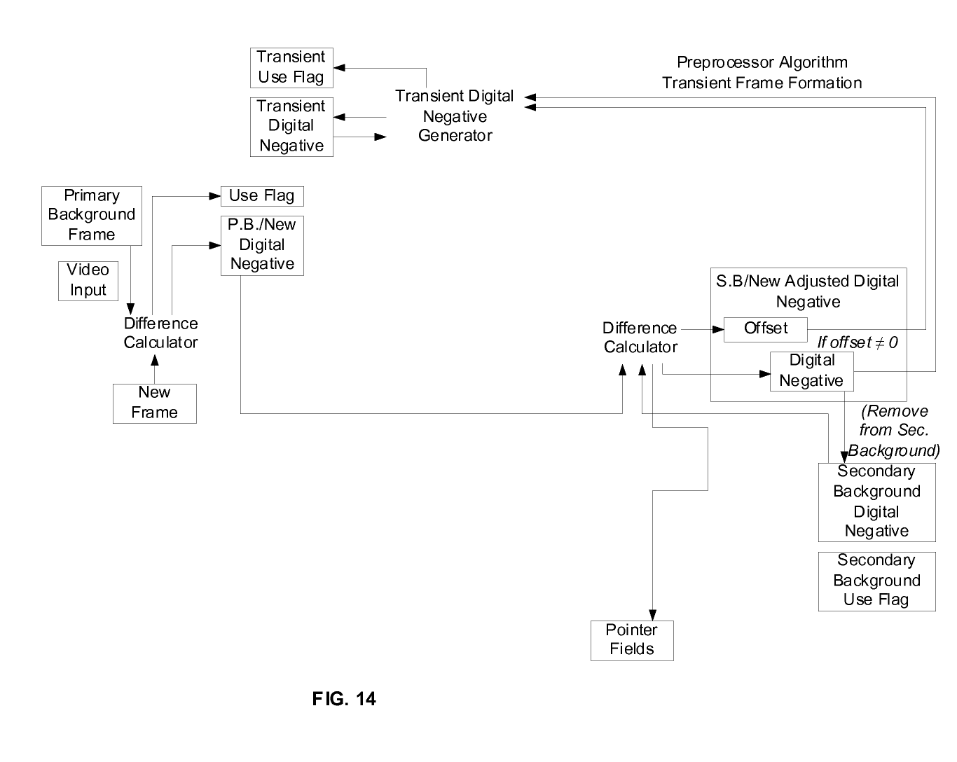

FIG. 14.

Since the moving object has been determined not to be part of the secondary background, the moving object is removed from the secondary background. More generally, it will be appreciated that the preprocessor algorithm maintains 1) a primary background file, 2) a secondary background file for holding new or relatively unmoving objects, and 3) a transient file for holding objects moving across the target area. It will be appreciated that other files may be maintained for tracking other types of image information. Also it will be appreciated that the preprocessor algorithm has been explained by requiring an offset of “0,0” to indicate certain static or transient conditions. It will be appreciated that other values may be used to accommodate jitter or minor movements. For example, any offset less then “5,5” may be assumed to be static.

FIG. 15.

FIG. 15 shows the comparison information is also compressed and communicated to the receiver. In this way, the receiver may generate its own transient file like the file the camera, and the receiver may also update the secondary file in the same manner as done on the camera preprocessor.

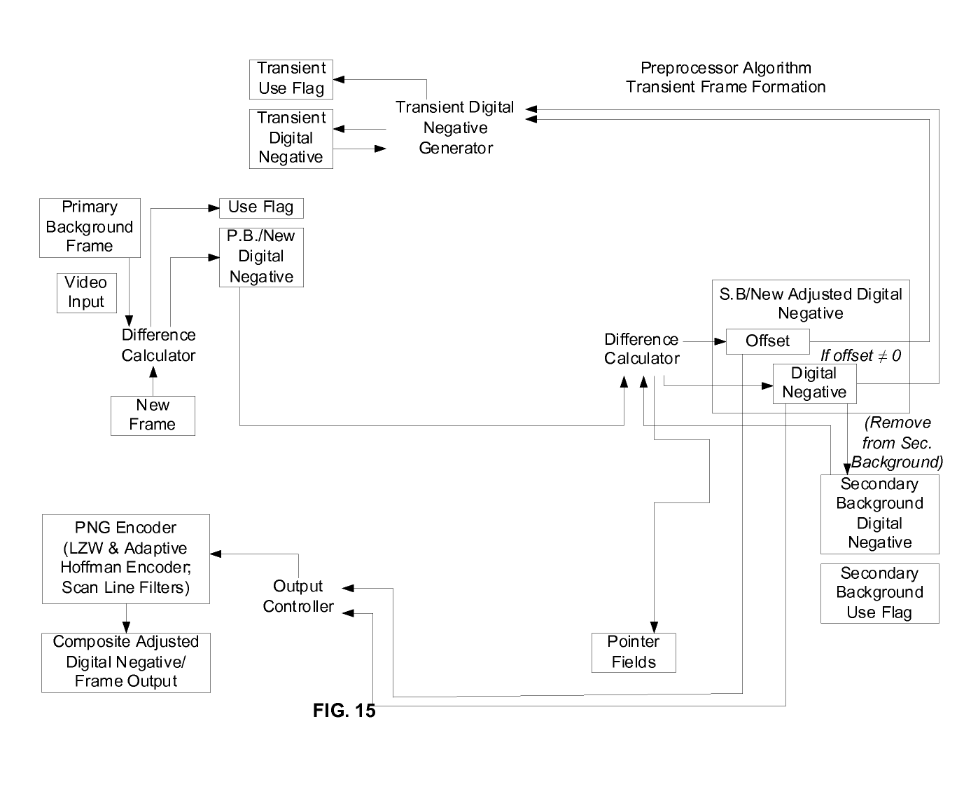

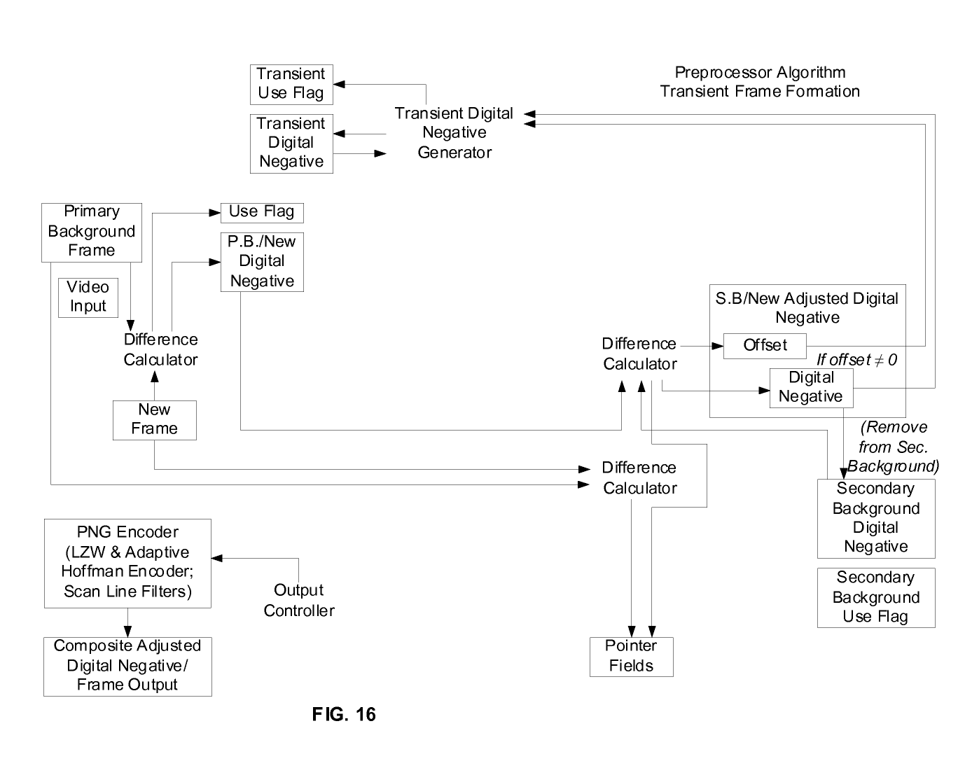

FIG. 16.

The transient a file has now been updated according to the third frame, and objects identified in the third frame as being transients have been removed from the secondary background. Now the secondary background process described with references to FIG. 03 to FIG. 07 is performed between the third frame and the primary background frame. In this way, newly appearing pixels, blocks, or objects may be added to the secondary background. As shown in FIG. 16, the primary background frame is compared to the third (new) frame according to a difference calculator.

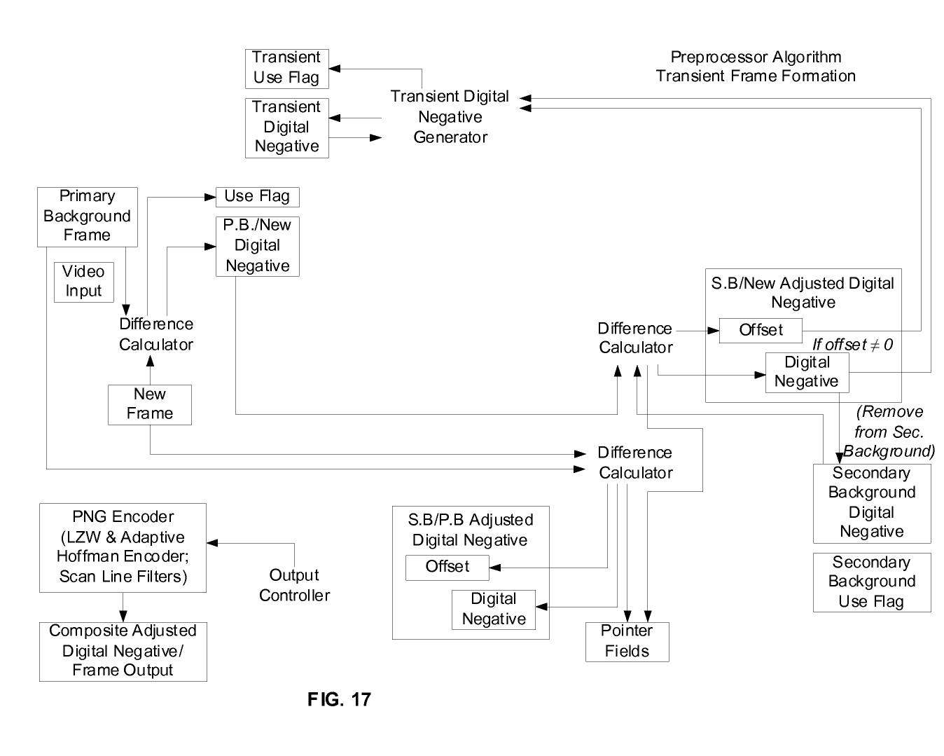

FIG. 17.

FIG. 17 shows that the comparison between the primary background and the third frame generates a secondary background/primary background adjusted digital negative.

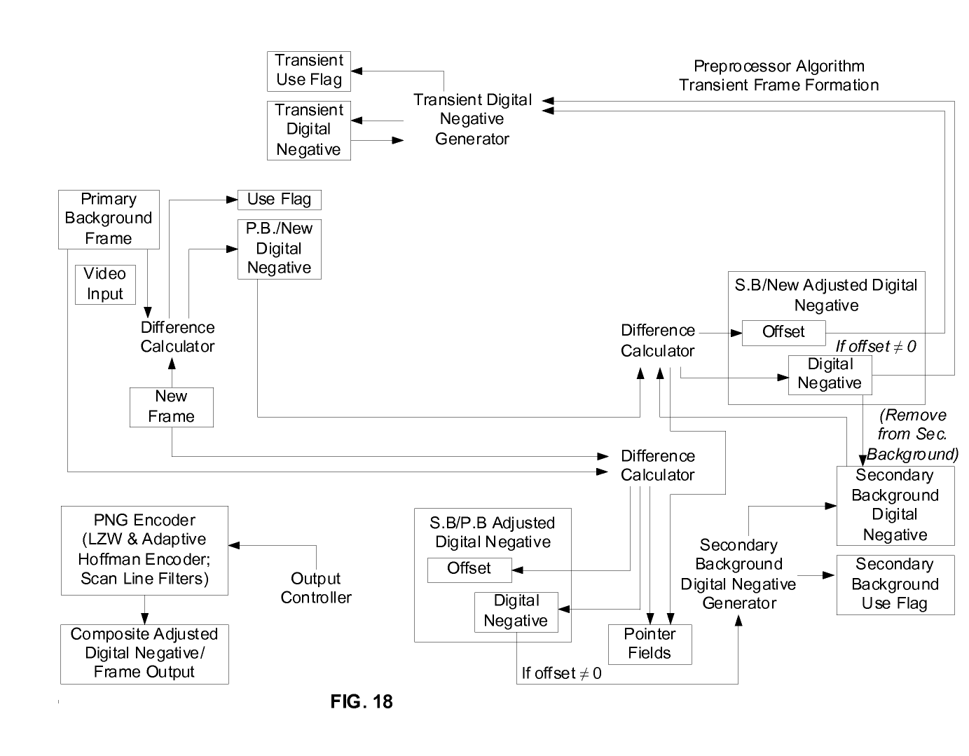

FIG. 18.

FIG. 18 shows that the secondary background/primary background adjusted digital negative is used to update the secondary background and the secondary background use flag. In this way, newly identified objects in the third frame are added into the secondary background.

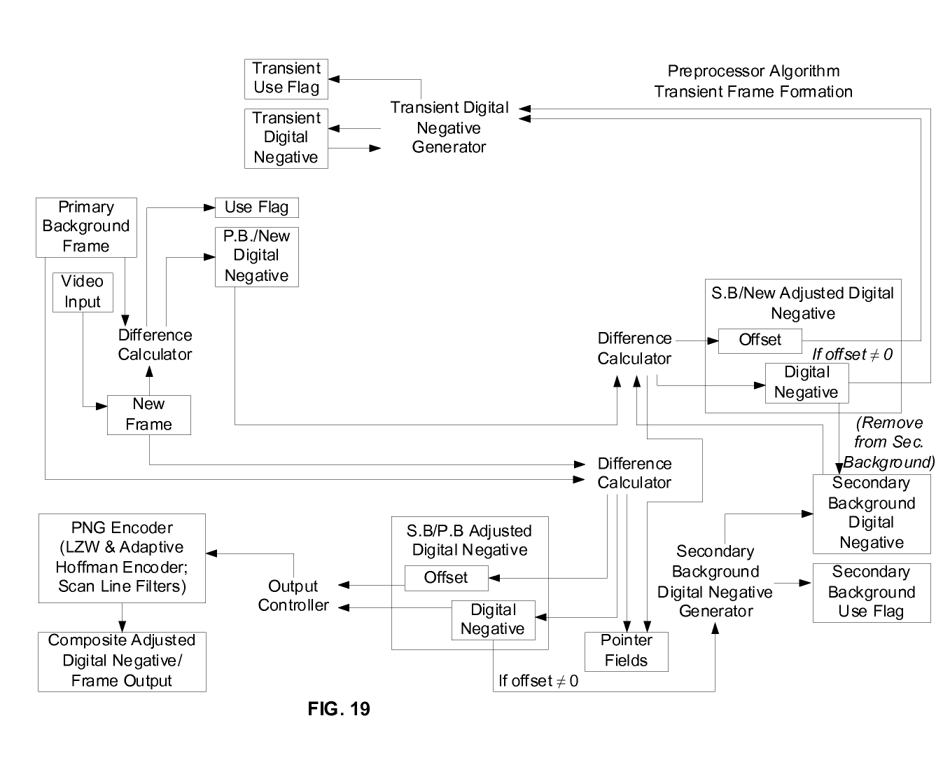

FIG. 19.

FIG. 19 shows that the secondary background/primary background adjusted digital negative information is compressed and communicated to the receiver. In this way, the receiver may update its secondary background file like has been done by the camera preprocessor algorithm. As more fully described above, the receiver process the adjusted digital negatives with an appropriate reference or background file to create a frame like the “new frame” captured by the camera.

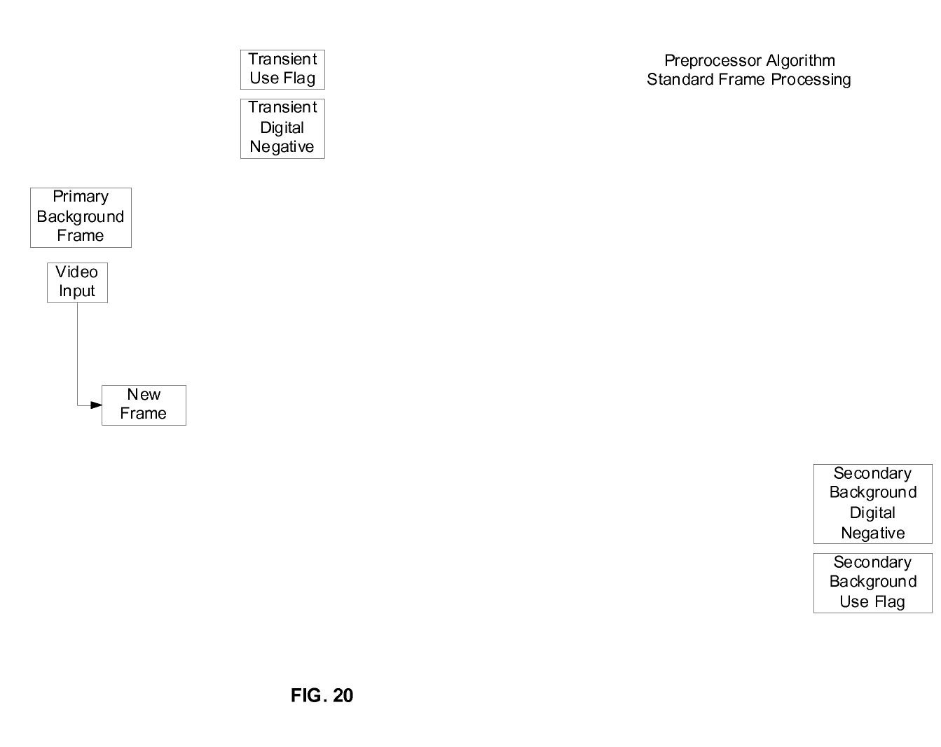

FIG. 20.

FIG. 20 to FIG. 35 describe standard frame processing. The standard frame processing assumes that the camera and the receiver have the primary background frame, secondary background frame, and transient frame. Generally, each new frame will be compared against the primary background, against the secondary background, and against the transient file. By maintaining this hierarchical structure of image data, the amount of information communicated between the camera and receiver can be dramatically reduced. Although the file hierarchy illustrated has three levels, it will be appreciated that additional levels may be used for other applications. Since the preprocessor algorithm described herein of assumes a fixed camera position, a limited number of hierarchy levels has been found to be effective. However, it will be appreciated that additional levels of image data and may be useful in a more dynamic environment. FIG. 20 shows that a new frame of video data has been captured.

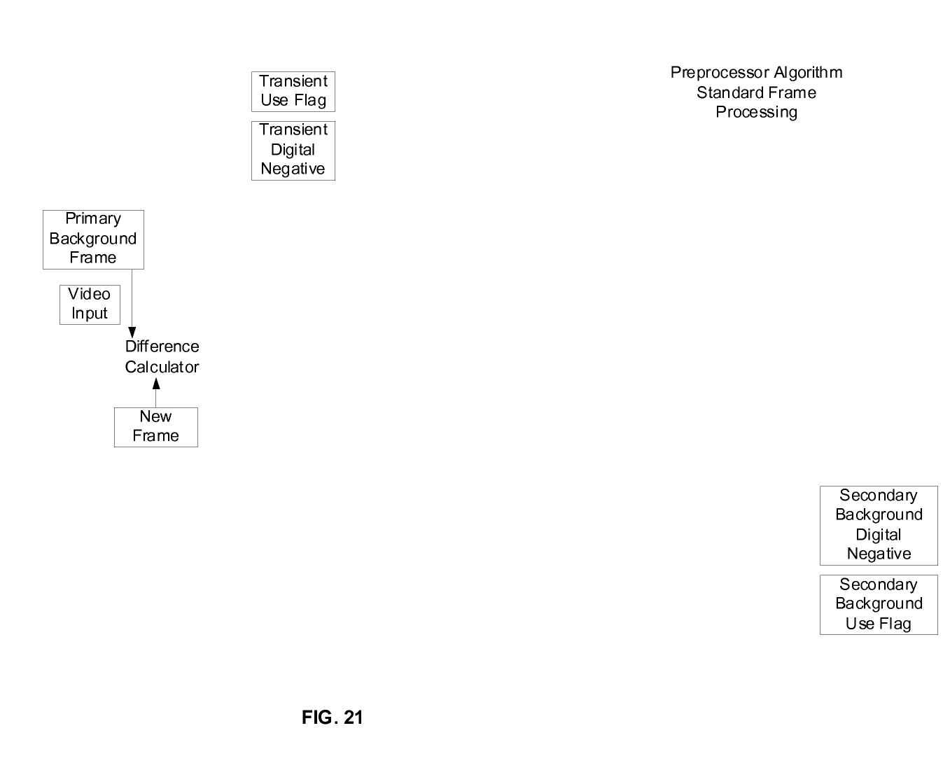

FIG. 21.

FIG. 21 shows that the new frame is a first compared to the primary background frame using a difference calculator.

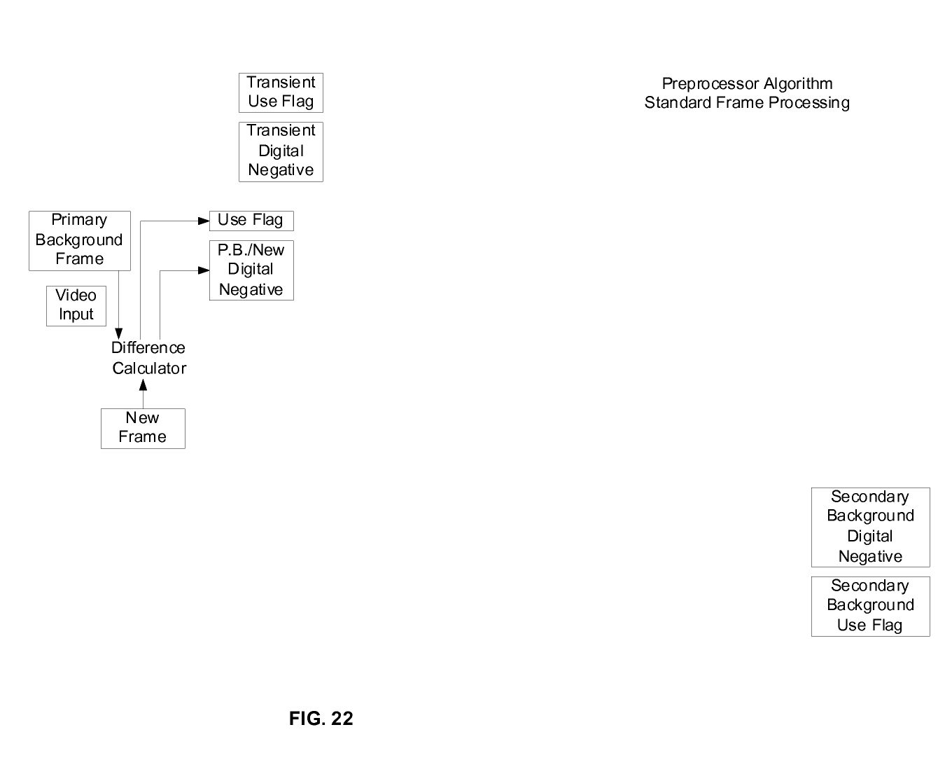

FIG. 22.

FIG. 22 shows differences between the primary background and the new frame are identified in a digital negative and use flag.

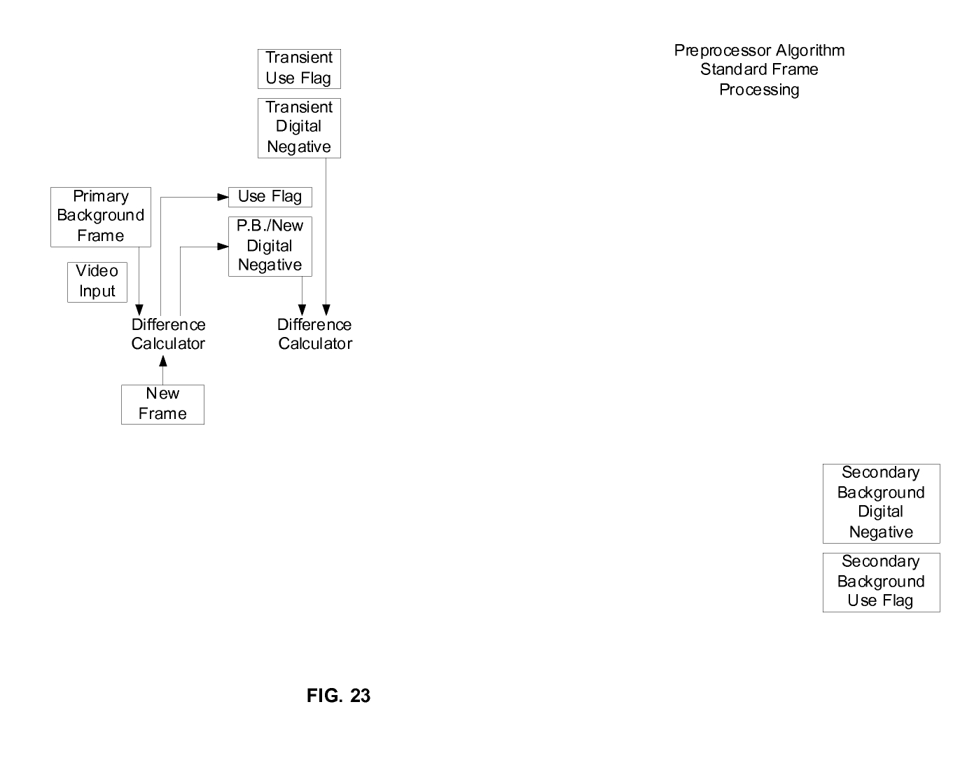

FIG. 23.

FIG. 23 shows that the difference file is compared with the transient file.

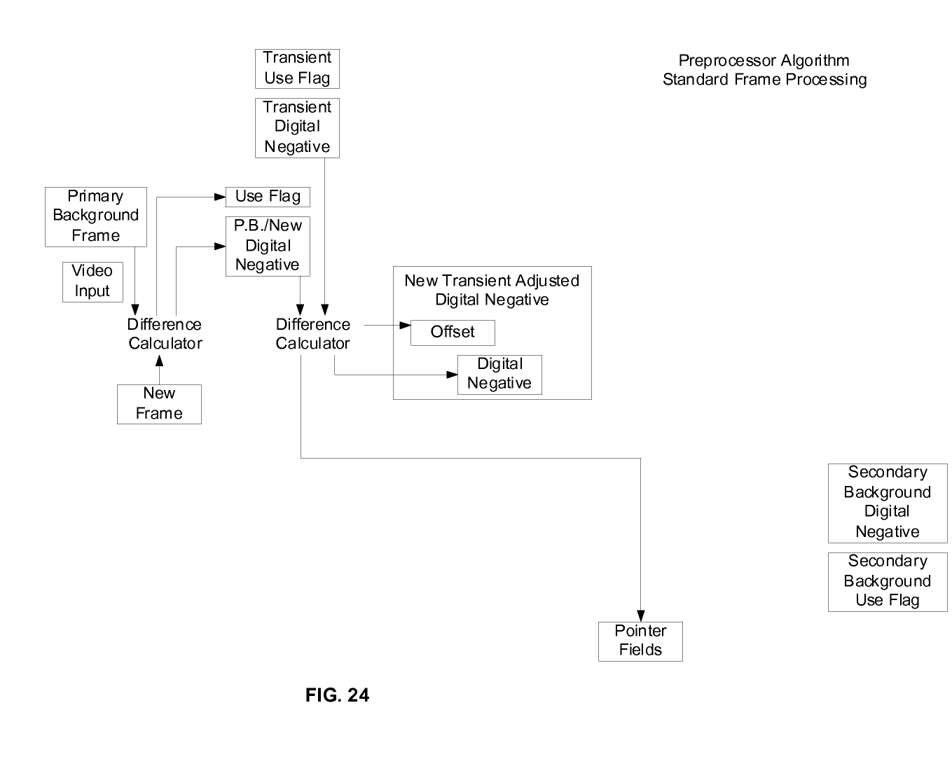

FIG. 24.

The comparison described with reference to FIG. 23 identifies a “new” or update transient file with a set of offsets and a digital negative. Generally, this file will be indicative of already identified transients motion.

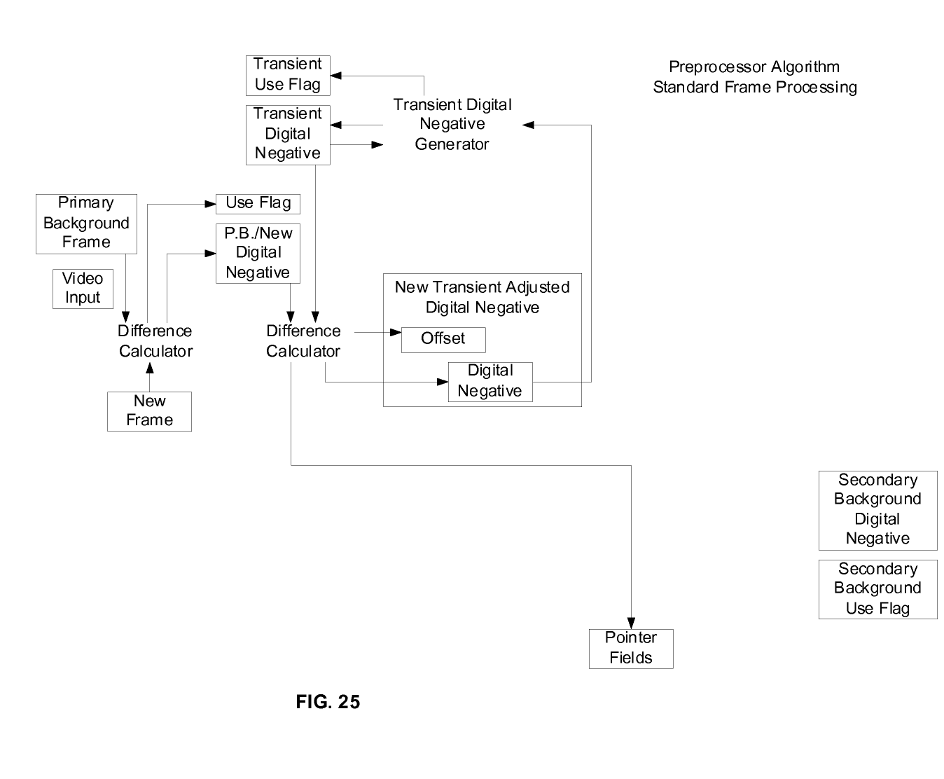

FIG. 25.

FIG. 25 shows that the update or a new transient file is used to update the stored transient file to the current position of the transients.

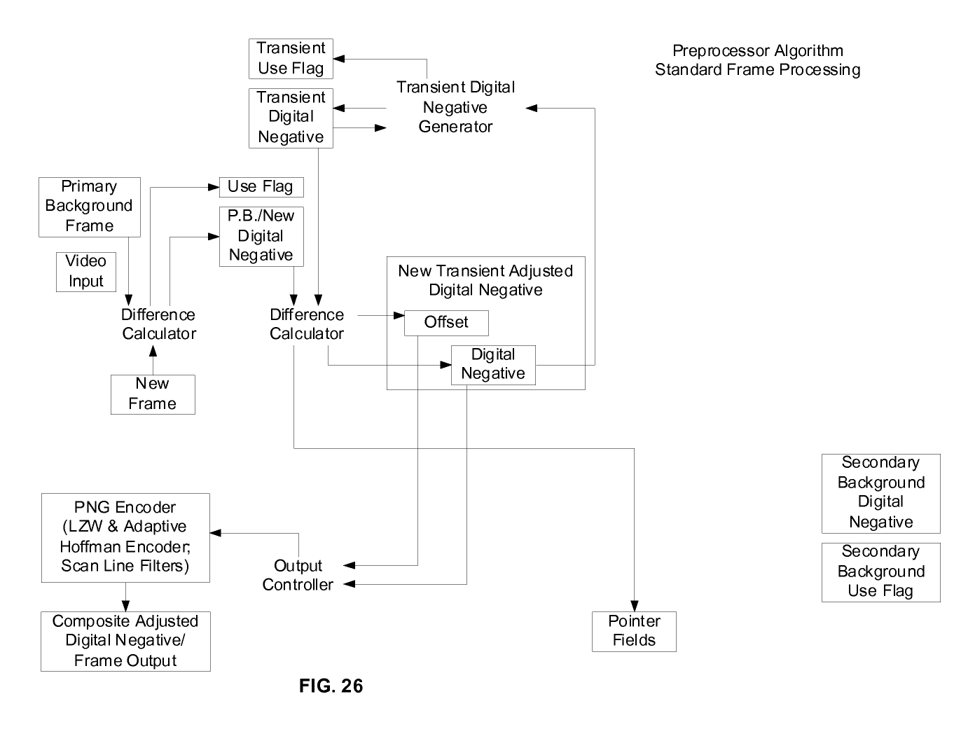

FIG. 26.

FIG. 26 shows that the update or new transient information is also communicated to the receiver. In this way, the receiver may update its transient file to indicate the current location of the transients.

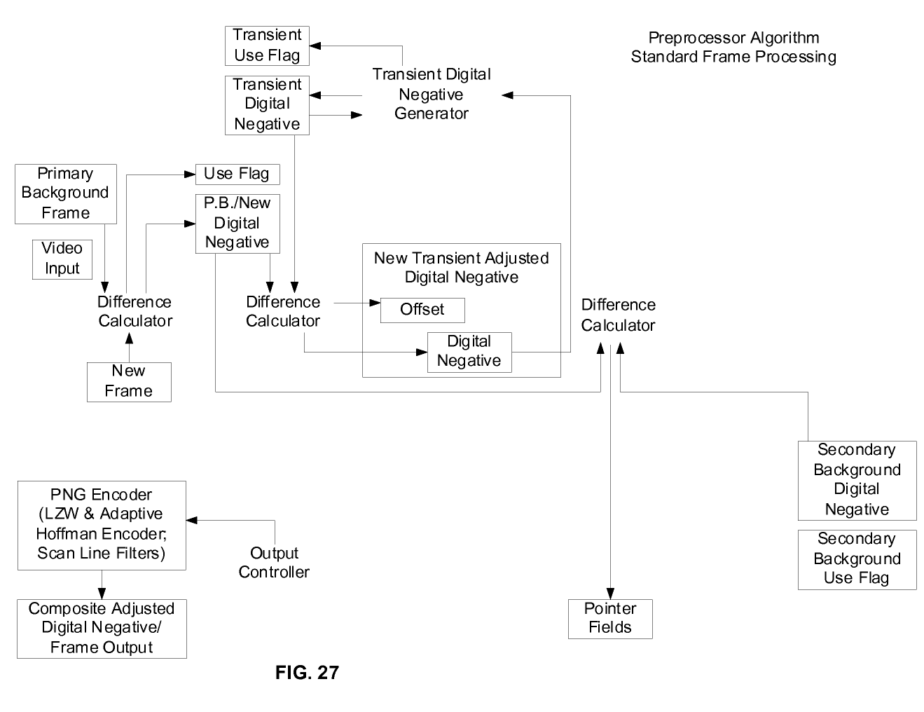

FIG. 27.

FIG. 27 shows that the differences between the new frame and the primary background frame are compared to the secondary background file. Generally, this comparison determines if an object, which is not in the primary background frame, has been previously added to the secondary background. (See FIG. 11).

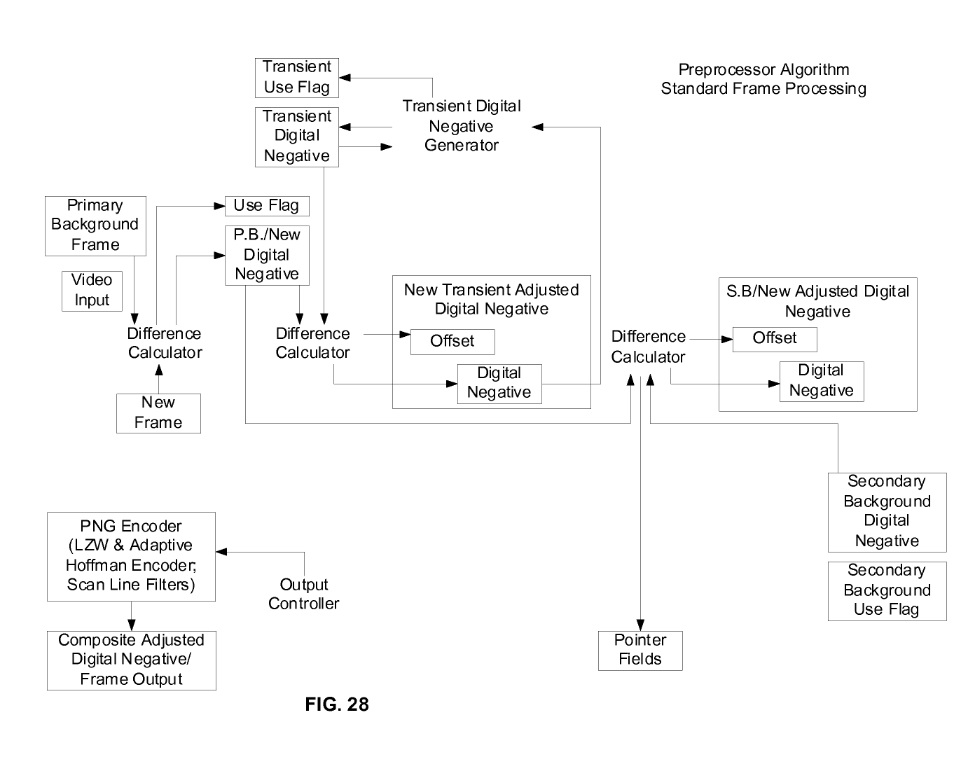

FIG. 28.

More particularly, the comparison discussed in FIG. 27 generates a digital negative and offset value comparing the secondary background to the new frame. If the digital negative has objects with an offset of “0,0”, this is indication that this object is not moving, and therefore may stay in the secondary background file. However, if an object is offset from its position in the secondary background, that object may then be identified as a transient moving in the target area. (See FIG. 12).

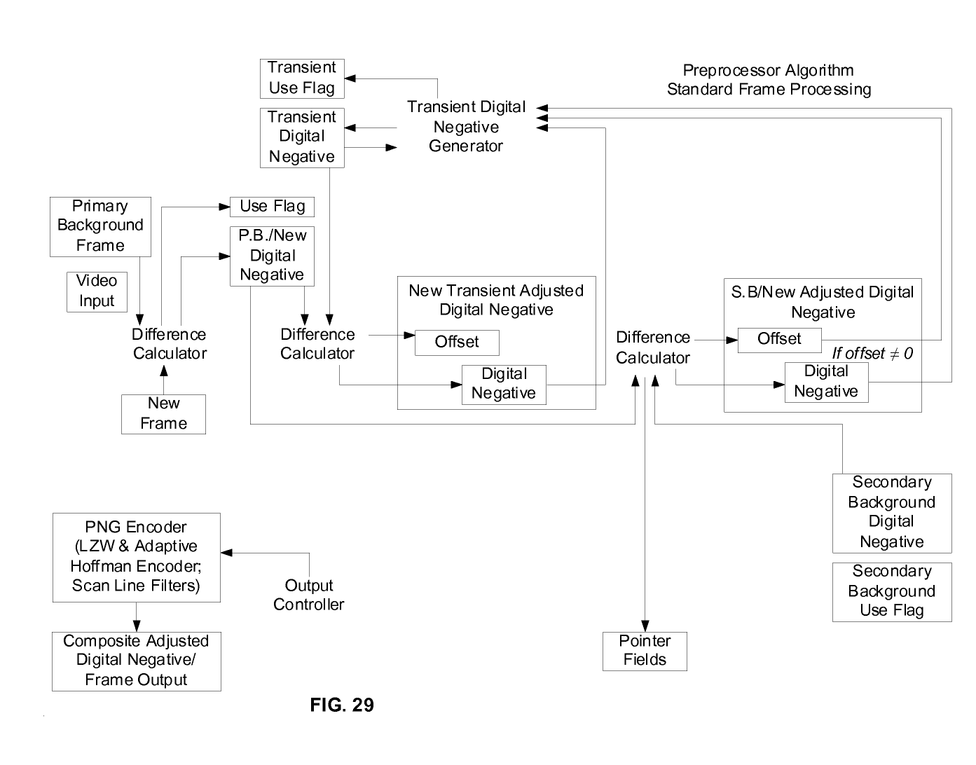

FIG. 29.

Continuing the description from FIG. 28, for those objects, pixel blocks, or pixels that are offset from their position in the secondary background, those moving objects are used to update the transient file. (See FIG. 13).

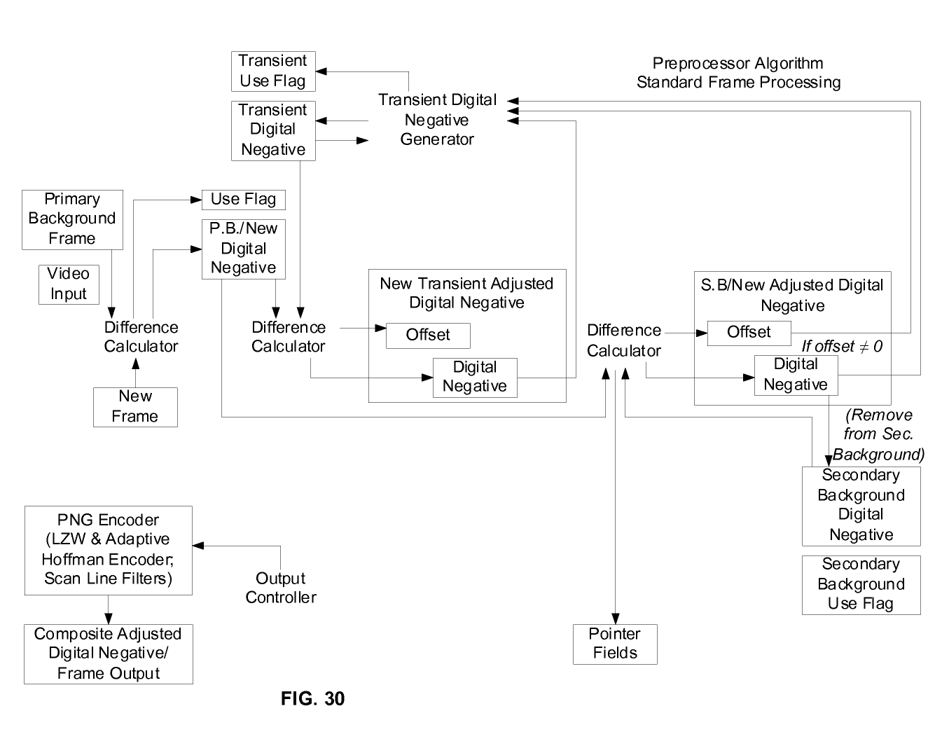

FIG. 30.

Since the moving object has been determined not to be part of the secondary background, the moving object is removed from the secondary background. (See FIG. 14).

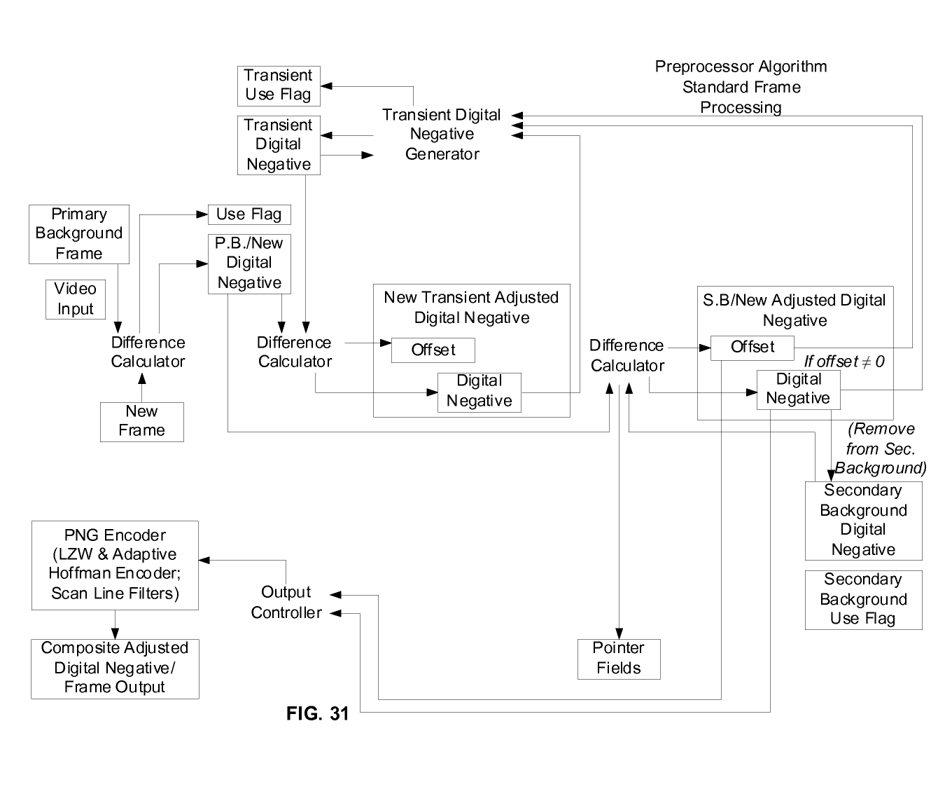

FIG. 31.

FIG. 31 shows the comparison information is also compressed and communicated to the receiver. In this way, the receiver may generate its own transient file like the file the camera, and the receiver may also update the secondary file in the same manner as done on the camera preprocessor. (See FIG. 15).

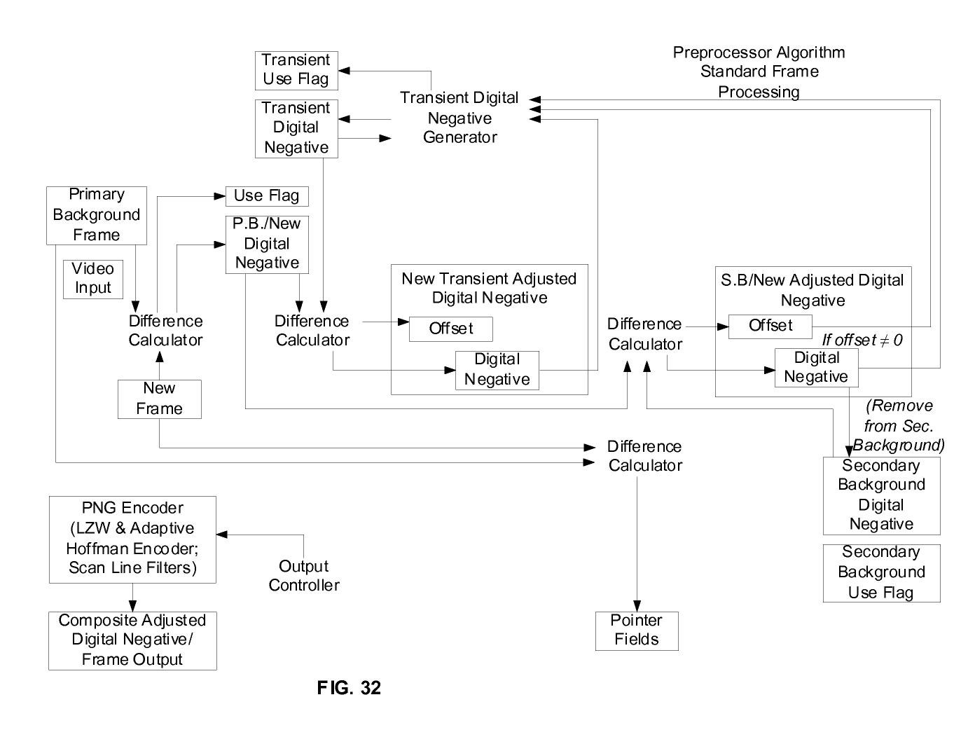

FIG. 32.

The transient a file has now been updated according to the new frame, and objects identified in the new frame as being transients have been removed from the secondary background. Now the secondary background process described with references to FIG. 03 to FIG. 07 is performed between the new frame and the primary background frame. In this way, newly appearing pixels, blocks, or objects may be added to the secondary background. As shown in FIG. 32, the primary background frame is compared to the new frame according to a difference calculator. (See FIG. 16)

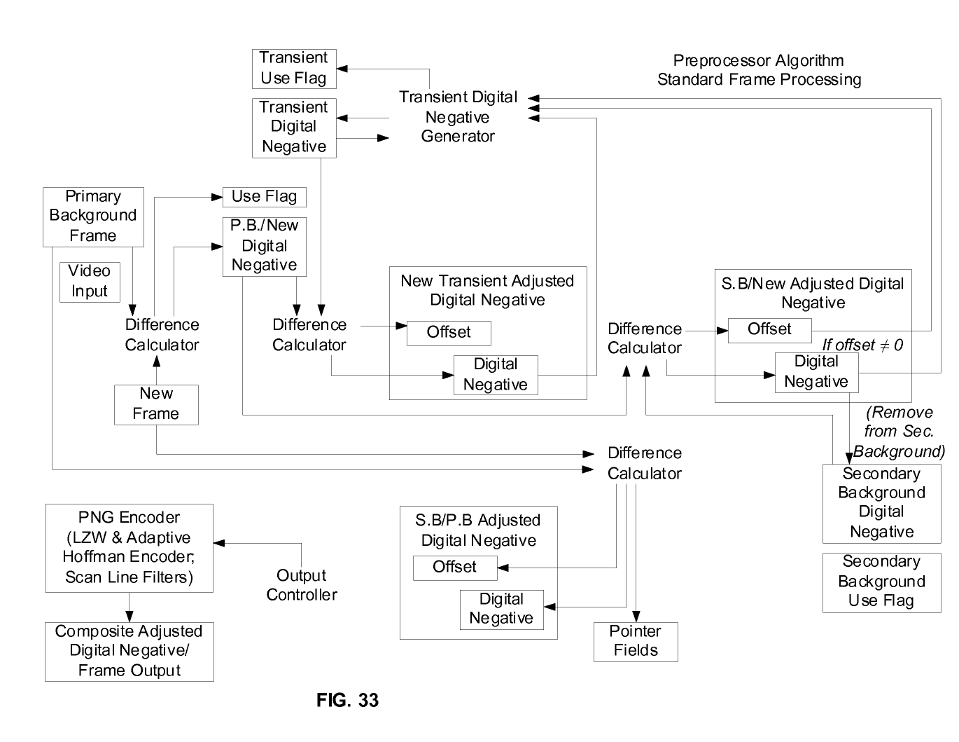

FIG. 33.

FIG. 33 shows that the comparison between the primary background and the third frame generates a secondary background/primary background adjusted digital negative. (See FIG. 17).

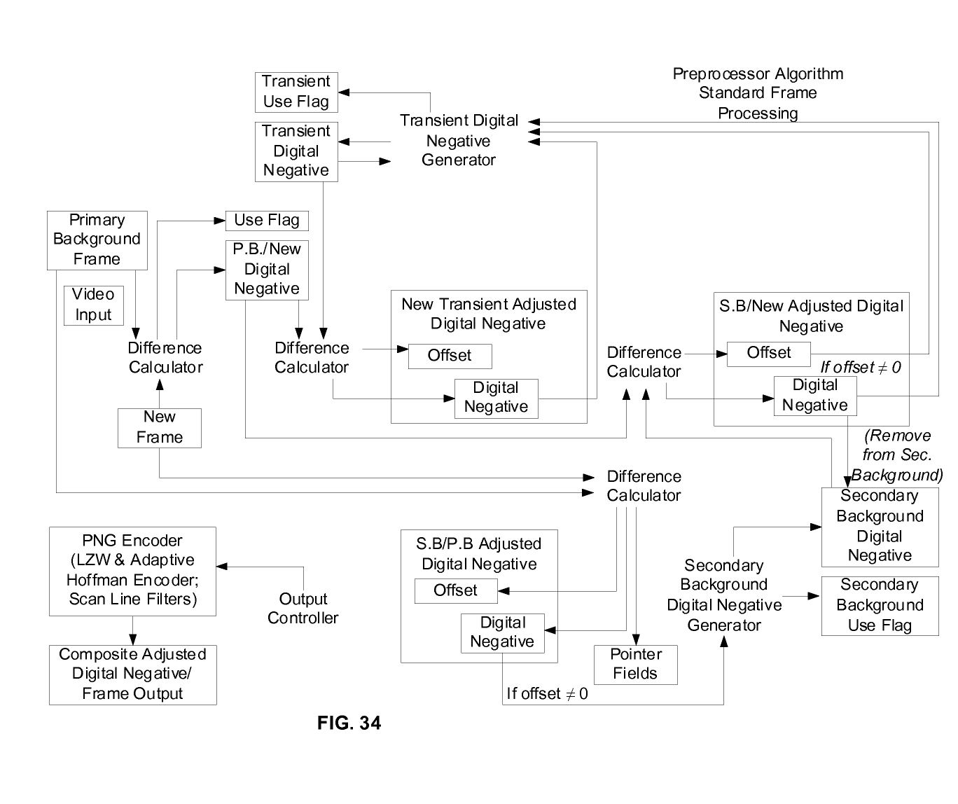

FIG. 34.

FIG. 34 shows that the secondary background/primary background adjusted digital negative is used to update the secondary background and the secondary background use flag. In this way, newly identified objects in the new frame are added into the secondary background. (See FIG. 18).

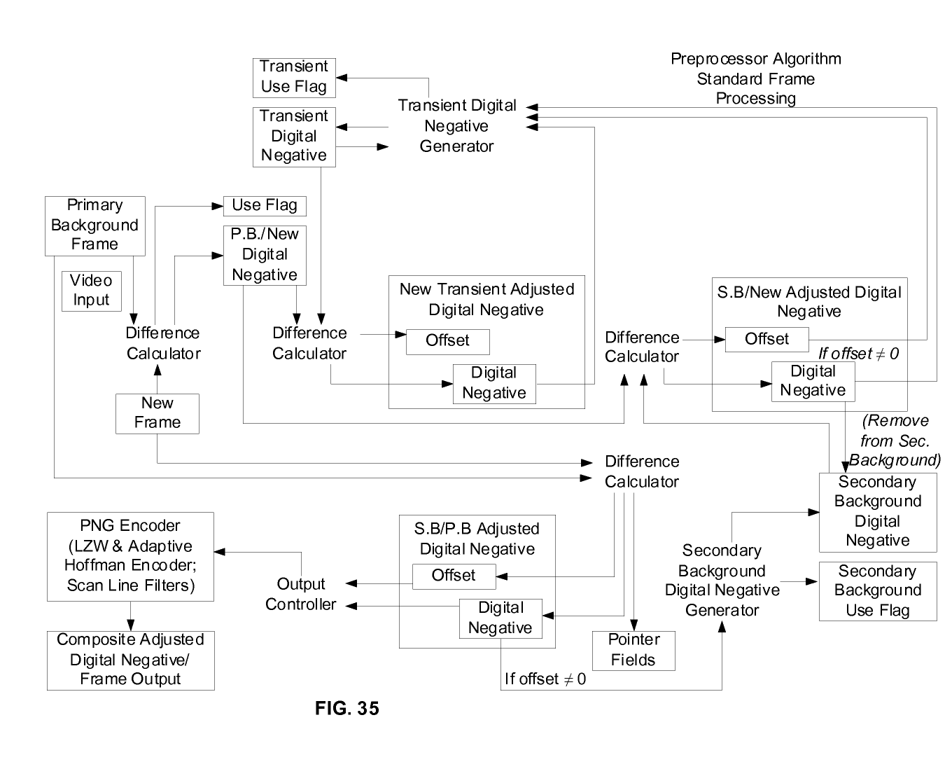

FIG. 35.

FIG. 35 shows that the secondary background/primary background adjusted digital negative information is compressed and communicated to the receiver. In this way, the receiver may update its secondary background file like has been done by the camera preprocessor algorithm. (See FIG. 19). As more fully described above, the receiver process the adjusted digital negatives with an appropriate reference or background file to create a frame like the “new frame” captured by the camera.

While particular example and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended claims.

What is claimed, is:

1. A process for capturing and compressing security image information, comprising:
capturing a background image;
transmitting the background image for use by a receiver;
a) capturing an image;
b) comparing the image to the background image;
c) generating a change file responsive to the comparison;
d) transmitting the change file for use by the receiver;
repeating steps a-d for a sequence of images;
receiving feedback information from the receiver; and
adjusting step a, b, c, or d responsive to the feedback information.

2. The process according to claim 1, further including the step of generating a transient file, the transient file for aggregating changes responsive to the comparison.

3. The process according to claim 1, wherein generating the change file comprises identifying pixels or blocks in the transient file that have moved, and generating offset values.

4. The process according to claim 1, wherein generating the change file comprises identifying new pixels or blocks not in the background.

5. The process according to claim 1, wherein generating the change file comprises identifying pixels or blocks that have moved, and generating offset values.

6. The process according to claim 1, wherein the feedback information comprises block size information, resolution information, window size information, threshold information, or motion estimation information.

7. A security system, comprising:
a camera system comprising:
a sensor having a fixed relationship with a security target;
the camera system operating the steps of:
capturing a background frame
transmitting the background frame to a receiver;
capturing a sequence of images;
generating a change file for each changed ones of the captured images;
transmitting the change file to the receiver;
a receiver system comprising:
a display;
a receiver;
the receiver system operating the steps of:
receiving and storing the background frame;
displaying the background frame on the display;
receiving the change file;
generating an overlay indicative of the change file;
displaying the overlay on the display; and
transmitting, from time to time, feedback information to the camera system.

8. The process according to claim 7, wherein the feedback information comprises block size information, resolution information, window size information, threshold information, or motion estimation information.

9. A process for processing image information, comprising:
retrieving a predefined graphical filter file;
a) capturing a new image;
b) comparing the image to the graphical filter file;
c) generating a change file responsive to the comparison;
d) transmitting the change file for use by a receiver; and
repeating steps a-d for a sequence of images;
receiving feedback information from the receiver; and
adjusting step a, b, c, or d responsive to the feedback information.

10. The process according to claim 9, wherein the predefined graphical filter file is a background image file.

11. The process according to claim 9, further including the step of transmitting the graphical filter file to a receiver.

12. The process according to claim 9, further including the steps of:
selecting a portion of the change file; and
adding the selected portion to the graphical filter file.

13. The process according to claim 12, further including the step of transmitting the selected portion to a receiver.

14. The process according to claim 12, wherein the predefined graphical filter file is a background image file and the selected portion is a set of pixels to be added to the background image file.

15. The process according to claim 9, wherein the feedback information comprises block size information, resolution information, window size information, threshold information, or motion estimation information.

16. A camera, comprising:
a sensor;
a memory storing a filter image; and
a processor operating the steps of:
a) capturing a new image;
b) comparing the new image to the filter image;
c) generating a change file responsive to the comparison;
d) receiving feedback information from a cooperating receiver or computer; and
e) adapting camera operation according to the received feedback information.

17. The camera according to claim 16, further including:
a radio, and
wherein the processor further operates the step of transmitting, using the radio, the change file to a receiver.

18. The camera according to claim 16, further including:
a network interface connection, and
wherein the processor further operates the step of transmitting, using the network interface connection, the change file to a receiver.

19. The process according to claim 16, wherein the feedback information comprises block size information, resolution information, window size information, threshold information, or motion estimation information.
